(19) United States
(12) Patent Application Publication
(10) Pub. No.: US 2019/0119559 A1
(43) Pub. Date: Apr. 25, 2019

(54) PREFORMED PARTICLE GEL FOR ENHANCED OIL RECOVERY

(71) Applicant: KEMIRA OYJ, Helsinki (FI)

(72) Inventors: Michael O'Toole, Marietta, GA (US); James Conner Lord, Roswell, GA (US)

(21) Appl. No.: 16/163,826

(22) Filed: Oct. 18, 2018

Related U.S. Application Data
(60) Provisional application No. 62/574,010, filed on Oct. 18, 2017.

(51) Int. Cl. C09K 8/588; C09K 8/594; E21B 43/16; E21B 43/20

(52) U.S. Cl. CPC C09K 8/588; E21B 43/20; E21B 43/166; C09K 8/594

(57) ABSTRACT

Re-crosslinkable preformed particle gels and compositions containing, e.g., those further comprising at least one re-crosslinking agent are provided, as well as the use thereof, e.g., in methods, processes, and techniques related to enhanced oil recovery, e.g., conformance control, wherein the use of said re-crosslinkable preformed particle gels when re-crosslinked may improve hydrocarbon recovery, e.g., by improving sweep efficiency. These re-crosslinkable preformed particle gels and compositions containing are also useful in water and gas shutoff, fluid loss control, zone abandonment, water and gas coning, squeeze and recompletion, chemical liner completions and lost circulation during drilling operations and plugging during drilling and drilling completion.

### CROSS-REFERENCE TO RELATED APPLICATIONS

This application claims the priority benefit of U.S. Provisional Patent Application No. 62/574,010, filed Oct. 18, 2017, which corresponds to attorney docket number 49704.1600, entitled “PREFORMED PARTICLE GEL FOR ENHANCED OIL RECOVERY”, which is hereby incorporated by reference in its entirety.

### FIELD OF THE ART

The present disclosure generally relates to preformed particle gels and the use thereof in processes and techniques related to enhanced oil recovery, e.g., conformance control.

### BACKGROUND

Enhanced oil recovery (EOR) generally refers to techniques and processes that can be used to increase the amount of unrefined petroleum (for example, crude oil) that may be extracted from an oil reservoir (for example, an oil field). By way of example, using EOR, about 40-60% of the reservoir's original oil can typically be extracted, compared with only 20-40% using traditional primary and secondary recovery techniques (for example, by water injection or natural gas injection). However, many reservoirs from which oil and gas may be produced may be heterogenous in their geologic properties (e.g. porosity and/or permeability). For some reservoirs, permeability differences among the different geologic layers can vary as much as several orders of magnitude.

In general a fluid, such as water, may be injected into an injection well. The injected water may mobilize and push some of the oil in place to a nearby production well where the oil and injected fluid may be co-produced. A high degree of heterogeneity in the permeability among the geologic layers of rock that contain oil within its porous spaces in the subsurface reservoir may cause such water injections to lack uniformity, with the larger proportion of the water entering into higher permeability geologic layers, which may lead to non-uniform displacement of the oil within the reservoir, such that most of the oil may be quickly mobilized from high permeability layers and little mobilized from the lower permeability layers. Such conditions may result in fluid exiting production wells having a higher than desired percentage of water and a lower than desired percentage of oil. Based on the foregoing, it is desirable to develop compositions and methods for use with EOR processes that improve the recovery of the large volume of oil that may remain in the bypassed and not yet swept lower permeability regions of a reservoir, and that minimize the loss of water from production wells during EOR processes.

One approach to improve the oil displacement process is through the use of means which selectively block or increase the flow resistance of high permeability geologic zones (sometimes referred to as “thief zones”). Blocking and/or increasing the flow resistance of these high permeability zones may result in the diversion of injected water to lower permeability zones, which may contain oil whose recovery is desired.

### BRIEF SUMMARY

The present embodiments relate to one or more re-crosslinkable preformed particle gels (“PPGs”) and the use thereof, particularly in enhanced oil recovery processes. More specifically, the present disclosure generally relates to one or more re-crosslinkable, swellable preformed particle gels (“PPGs”) or a water or other aqueous composition containing said one or more re-crosslinkable, swellable PPGs wherein said one or more re-crosslinkable PPG when re-crosslinked with at least one re-crosslinker is suitable for use as a conformance control agent, wherein said one or more PPGs are dispersible in water or other aqueous composition and said one or more PPGs comprise a sufficient amount or number of soluble linear chains to facilitate re-crosslinking. In some embodiments, said re-crosslinkable PPGs are produced by a polymerization process which includes the addition of a covalent crosslinking agent. In some embodiments, said re-crosslinkable PPGs are produced by a polymerization process which does not include an ionic crosslinking agent. In some embodiments, said re-crosslinkable, swellable PPGs or composition containing said re-crosslinkable PPGs may further comprise at least one re-crosslinker. In some embodiments, said at least one re-crosslinker may be added before, during, and/or after swelling. In some embodiments, said at least one re-crosslinker may be added when the re-crosslinkable PPG is in an unswollen, partially swollen, and/or substantially swollen state. In some embodiments, said water or other aqueous composition may comprise brine, produced water, flowback water, brackish water, and/and sea water. In some embodiments one or more re-crosslinkable, swellable PPGs comprising a sufficient amount of soluble linear chains to facilitate re-crosslinking or composition containing said re-crosslinkable PPGs may be produced under conditions which result in a decreased degree of cross-linking, which may be accomplished by different means, such as, but not limited to, the use of reduced amounts of cross-linker, the usage of less efficient cross-linkers, the usage of specific monomers or monomer combinations, a reduced duration of the cross-linking reaction, and/or the addition of one or more polymers comprising soluble linear chains or any combination of the foregoing. In some embodiments, said soluble linear chains may result in whole or part by a decreased level of crosslinking during formation of said one or more re-crosslinkable, swellable PPGs. In some embodiments, re-crosslinkable, swellable PPGs or composition containing said re-crosslinkable PPGs may comprise a decreased level of crosslinking which results in decreased swell capacity and increased strength (elongation) upon the addition of a re-crosslinker and/or re-crosslinking of the re-crosslinkable PPG particles to bond the re-crosslinkable PPG particles together according to some embodiments. In some embodiments, re-crosslinkable, swellable PPGs or composition containing said re-crosslinkable PPGs may comprise a decreased level of crosslinking which results in increased swell capacity and increased strength (elongation) upon the addition of a re-crosslinker and/or re-crosslinking of the re-crosslinkable PPG particles to bond the re-crosslinkable PPG particles together according to some embodiments. For example, in some instances, e.g., dependent upon the particular brine conditions, re-crosslinkable PPGs comprising acrylamide and acrylic acid, e.g., re-crosslinkable PPGs comprising 90% acrylamide and 10% acrylic acid, may comprise a higher value of swell capacity for crosslinker levels of between 10 ppm to about 45 ppm as compared to re-crosslinkable PPGs comprising acrylamide and acrylic acid where the crosslinker level is higher, e.g., about 100 ppm or more. This may occur because for a given re-crosslinkable PPG composition the particular brine conditions where the re-crosslinkable PPGs are present may impact the crosslinker levels for which swell capacity is maximal (i.e., for a particular re-crosslinkable PPG composition). This variability may be taken into account by assaying swell capacity of different re-crosslinkable PPG compositions according to the invention under different brine conditions, including the brine conditions of the environment where the re-crosslinkable PPGs are to be used in conformance control. Similarly, in some instances, e.g., under certain brine conditions, re-crosslinkable PPGs comprising acrylamide and acrylic acid, such as 70% acrylamide and 30% acrylic acid, may comprise a higher value of swell capacity for crosslinker levels of between 15 ppm to about 35 ppm as compared to re-crosslinkable PPGs comprising acrylamide and acrylic acid where the crosslinker level is about 100 ppm or more. Again this may occur because for a given re-crosslinkable PPG composition the particular brine conditions may impact the crosslinker levels for which swell capacity is maximal; however this variability may be taken into account by assaying swell capacity of re-crosslinkable PPG compositions according to the invention under different brine conditions, including the brine conditions of the environment where the particular re-crosslinkable PPGs are to be used in conformance control. Furthermore, the decrease in crosslinker level which results in increased swell capacity and increased strength (elongation) may also be due in part to the presence of increasing amounts of soluble linear chains.

According to some embodiments, said soluble linear chains may be provided in whole or part by the polymers comprising soluble linear chains. In some embodiments, said soluble linear chains provide for improved viscoelastic strength upon the addition of a re-crosslinking agent and/or re-crosslinking. In some embodiments, said re-crosslinking agent may comprise at least one ionic crosslinker. In some embodiments, said re-crosslinkable, swellable PPGs or composition containing said re-crosslinkable PPGs may comprise re-crosslinkable PPGs that may bond to one another upon re-crosslinking according to some embodiments. In some embodiments, said re-crosslinkable, swellable PPGs or composition containing said re-crosslinkable PPGs may be swollen above the surface, e.g., before use as a conformance control agent in a chosen environment.

Additionally, the present embodiments generally relate to a composition suitable for use in conformance control comprising: (i) one or more re-crosslinkable, swellable preformed particle gels (“PPGs”) which are suitable for use as a conformance control agent, wherein said re-crosslinkable PPGs are dispersible in water and comprise a sufficient amount or number of soluble linear chains to facilitate re-crosslinking and (ii) at least one re-crosslinker which is suitable for converting the re-crosslinkable PPG into a viscoelastic gel. Said composition may be suitable for use in one or more of (i) water and gas shutoff, (ii) fluid loss control, (iii) zone abandonment, (iv) water and gas coning, squeeze and recompletion, (v) chemical liner completions and lost circulation during drilling operations and (vi) plugging during drilling and drilling completion according to some embodiments. The present invention additionally generally pertains to a system for use in conformance control comprising (i) one or more re-crosslinkable, swellable preformed particle gels (“PPGs”) which are suitable for use as a conformance control agent as discussed herein; (ii) at least one re-crosslinker; and (iii) a subterranean formation having the composition therein.

Moreover, the present embodiments generally relate to a method for producing at least one PPG using re-crosslinkable PPGs or a composition comprising one or more re-crosslinkable PPGs as described herein, that may comprise (i) providing an aqueous composition comprising one or more re-crosslinkable PPGs as described herein, (ii) allowing the one or more re-crosslinkable PPGs in the composition to swell and (iii) adding an amount of at least one re-crosslinker sufficient to provide for re-crosslinking of the one or more re-crosslinkable PPGs, wherein the re-crosslinker is added before, during and/or after swelling. Additionally, the present embodiments generally encompass a method for re-crosslinking re-crosslinkable PPGs as discussed herein, that may comprise (i) providing an aqueous composition comprising one or more re-crosslinkable PPGs as described herein, (ii) allowing the one or more re-crosslinkable PPGs to swell and (iii) adding an amount of at least one re-crosslinker sufficient to provide for re-crosslinking of the one or more re-crosslinkable PPGs to bond together, wherein the re-crosslinker is added before, during and/or after swelling. Additionally, the present disclosure generally pertains to a method of enhanced oil recovery that may comprise: (i) obtaining or providing a composition comprising one or more re-crosslinkable PPGs and at least one re-crosslinker, as described herein; (ii) placing the composition in a subterranean formation downhole; and (iii) extracting material comprising petroleum from the subterranean formation downhole via a production wellbore.

Furthermore, the instant embodiments generally pertain to a method of conformance control, wherein said method comprises adding an amount of one or more re-crosslinkable and swellable preformed particle gels (“PPGs”) and at least one re-crosslinker that is effective to act as a conformance control agent, wherein said one or more re-crosslinkable PPGs comprise a decreased level of crosslinking resulting in re-crosslinkable PPGs that comprise an amount of linear chains sufficient to facilitate re-crosslinking. The various embodiments discussed herein also generally pertain to a composition or compositions comprising (i) one or more re-crosslinkable preformed particle gels (“PPGs”), which are dispersible in water and suitable for use as a conformance control agent wherein said re-crosslinkable PPGs comprise a sufficient amount or number of soluble linear chains to permit re-crosslinking and/or bonding of the re-crosslinkable PPGs, and (ii) at least one re-crosslinking agent, wherein optionally said composition or compositions are in the same or different packages. In some embodiments, a composition may comprise (i) one or more re-crosslinkable preformed particle gels (“PPGs”), which re-crosslinkable PPGs are dispersible in water and suitable for use as conformance control agents wherein said re-crosslinkable PPGs comprise a sufficient number or amount of soluble linear chains that permit re-crosslinking and/or bonding of the re-crosslinkable PPGs and said re-crosslinkable PPGs comprise less than 100 ppm of monomeric methylene bisacrylamide (“MBA”), and (ii) at least one a re-crosslinking agent, wherein optionally wherein said composition or compositions are in the same or different packages. Additionally, some embodiments generally relate to a method of conformance control, wherein said method may comprise the use of one or more re-crosslinkable preformed particle gels (“PPGs”), wherein said re-crosslinkable PPGs comprise soluble linear chains that permit re-crosslinking and/or bonding of the re-crosslinkable PPGs, and a re-crosslinking agent is added to said re-crosslinkable PPGs comprising soluble linear chains prior to, during or after conformance control.

Additionally, the present disclosure generally pertains to a method for remediation of a zone within a subterranean formation bearing heavy/viscous oil to inhibit breakthrough of water from a water injection well via the zone into a production well, the zone comprised of a void space, a halo region, or both, within the zone due to production of the heavy/viscous oil through the production well, the zone thereby allowing for pressure communication between the injection well and the production well, which method may comprise: (i) injecting a composition into the zone via the injection well, the composition comprising one or more re-crosslinkable PPGs comprising soluble linear chains and at least one re-crosslinker or a composition containing said one or more re-crosslinkable PPGs and said at least one re-crosslinker, as discussed herein; and (ii) allowing the one or more re-crosslinkable PPGs and the at least one re-crosslinker to set in the injection well for a time sufficient to thereby form re-crosslinked PPGs which form a plug which reduces flow communication of water between the injection well and the production well.

Moreover, the present embodiments also generally pertain to a method of improving production from an oil or gas well, that may comprise: (i) providing a formulation comprising one or more re-crosslinkable PPGs comprising soluble linear chains that permit re-crosslinking and/or bonding of the re-crosslinkable PPGs and at least one re-crosslinker or a composition containing said one or more re-crosslinkable PPGs and said at least one re-crosslinker, as discussed herein; and (ii) delivering the formulation into the oil or gas well, whereby the formulation results in the formation of re-crosslinked PPGs which improve production from the well. Additionally, the instant disclosure generally encompasses a method of water blocking or water shutoff in an oil or gas well that may comprise: (i) providing a formulation comprising one or more re-crosslinkable PPGs comprising soluble linear chains that permit re-crosslinking and/or bonding of the re-crosslinkable PPGs and at least one re-crosslinker or a composition containing said one or more re-crosslinkable PPGs and said at least one re-crosslinker as discussed herein; and (ii) delivering the formulation into the oil or gas well, whereby the formulation results in the formation of re-crosslinked PPGs which provide for water blocking or water shutoff in the well. Furthermore, in some embodiments, a method of enhancing oil recovery from an oil source may comprise providing a formulation comprising one or more re-crosslinkable PPGs comprising soluble linear chains that permit re-crosslinking and/or bonding of the one or more re-crosslinkable PPGs and at least one re-crosslinker or a composition containing said one or more re-crosslinkable PPGs and said at least one re-crosslinker as discussed herein; and (ii) delivering the re-crosslinkable PPG containing formulation into the oil source, whereby the formulation enhances oil recover from the oil source.

Additionally, the present embodiments generally relate to methods of treating a petroleum-containing formation to reduce sand production that may comprise providing a formulation comprising one or more re-crosslinkable PPGs comprising soluble linear chains that permit re-crosslinking and/or bonding of the re-crosslinkable PPGs and at least one re-crosslinker or a composition containing said one or more re-crosslinkable PPGs and said at least one re-crosslinker as discussed herein; and (ii) delivering said re-crosslinkable PPGs and at least one re-crosslinker or composition containing into the petroleum-containing formation, whereby the formulation results in the formation of re-crosslinked PPGs which reduce sand production in the formation. Moreover, the instant embodiments generally encompass methods of displacing fluid from a wellbore by viscous plug flow that may comprise: (i) providing one or more re-crosslinkable PPGs comprising soluble linear chains that permit re-crosslinking and/or bonding of the one or more re-crosslinkable PPGs and at least one re-crosslinker or a composition containing said one or more re-crosslinkable PPGs and said at least one re-crosslinker as discussed herein; and (ii) delivering the re-crosslinkable PPGs and at least one re-crosslinker into a wellbore, whereby the formulation forms a viscous plug in the wellbore by re-crosslinking of the one or more re-crosslinkable PPGs, thereby displacing fluid therefrom.

### BRIEF DESCRIPTION OF THE SEVERAL VIEWS OF THE DRAWING

FIG. 1 illustrates swell capacity measurements that were taken during the swell capacity experiments performed in accordance with Example 1.

FIG. 2 illustrates swell capacity measurements that were taken during the swell capacity experiments performed in accordance with Example 18.

FIG. 3 illustrates swell capacity measurements that were taken during the swell capacity experiments performed in accordance with Example 19.

### DETAILED DESCRIPTION

The present disclosure generally relates to one or more re-crosslinkable preformed particle gels, which in association with at least one re-crosslinker results in re-crosslinked preformed particle gels. Additionally the present disclosure generally relates to the use thereof in processes and techniques related to enhanced oil recovery, e.g., conformance control, wherein the use of said re-crosslinked preformed particle gels may improve hydrocarbon recovery, e.g., by improving sweep efficiency. These re-crosslinked preformed particle gels are also useful in water and gas shutoff, fluid loss control, zone abandonment, water and gas coning, squeeze and recompletion, chemical liner completions and lost circulation during drilling operations and plugging during drilling and drilling completion.

The present disclosure generally relates to one or more re-crosslinkable PPGs and processes involving the use of these PPGs, wherein such re-crosslinkable PPGs can be re-crosslinked by the addition of at least one re-crosslinker, thereby bonding together and producing compositions containing re-crosslinked PPGs having viscoelastic strength to provide for enhanced oil recovery, and/or whereby the use of said re-crosslinked PPGs can increase conformance control, such as the efficient blockage of high permeability zones.

Furthermore, some embodiments generally include one or more re-crosslinkable, swellable PPGs suitable for use as a conformance control agent, wherein said one or more re-crosslinkable PPGs are dispersible in water or other aqueous composition and comprise soluble linear chains which facilitate re-crosslinking and/or bonding of the one or more re-crosslinkable PPGs. Additionally, the present embodiments relate to a composition or compositions suitable for use in conformance control comprising: (i) one or more re-crosslinkable, swellable preformed particle gels (“PPG”) which are suitable for use as a conformance control agent, wherein said one or more re-crosslinkable PPGs are dispersible in water and comprise soluble linear chains which facilitate re-crosslinking; and (ii) at least one re-crosslinker which is suitable for converting the PPG into a viscoelastic gel comprising the re-crosslinked PPGs. In some embodiments, said composition or compositions are in the same or different packages. Moreover, the instant application generally encompasses a system for use in conformance control comprising (i) one or more re-crosslinkable, swellable preformed particle gels (“PPGs”) suitable for use as a conformance control agent according to the present embodiments; (ii) at least one re-crosslinker; and (iii) a subterranean formation having the composition therein.

### Definitions

As used herein the singular forms “a”, “and”, and “the” include plural referents unless the context clearly dictates otherwise. All technical and scientific terms used herein have the same meaning as commonly understood to one of ordinary skill in the art to which this invention belongs unless clearly indicated otherwise.

As used herein, the terms “polymer,” “polymers,” “polymeric,” and similar terms are used in their ordinary sense as understood by one skilled in the art, and thus may be used herein to refer to or describe a large molecule (or group of such molecules) that may comprise recurring units, such as monomers. Polymers may be formed in various ways, including by polymerizing monomers and/or by chemically modifying one or more recurring units of a precursor polymer. Unless otherwise specified, a polymer may comprise a “homopolymer” that may comprise substantially identical recurring units that may be formed by, e.g., polymerizing a particular monomer. Unless otherwise specified, a polymer may also comprise a “copolymer” that may comprise two or more different recurring units that may be formed by, e.g., copolymerizing, two or more different monomers, and/or by chemically modifying one or more recurring units of a precursor polymer. Unless otherwise specified, a polymer or copolymer may also comprise a “terpolymer” that may comprise three or more different recurring units. The term “polymer” as used herein is intended to include both the acid form of the polymer as well as its various salts.

Polymers may comprise nonionic, anionic, and/or cationic monomers. In some embodiments, the polymer may comprise a nonionic polymer that is later hydrolyzed to comprise carboxylate groups. In some embodiments, hydrolyzation can be produced by heat, adding metal or ammonium hydroxides or sodium carbonate. Polymers may be amphoteric in nature; that is, containing both anionic and cationic substituents, although not necessarily in equal proportions.

As used herein, the term “monomer” generally refers to nonionic monomers, anionic monomers, cationic monomers, zwitterionic monomers, betaine monomers, and amphoteric ion pair monomers.

As used herein the term “nonionic monomer” generally refers to a monomer that possesses a neutral charge. Nonionic monomers may comprise but are not limited to comprising monomers selected from the group consisting of acrylamide (“AMD”), methacrylamido, vinyl, allyl, ethyl, and the like, all of which may be substituted with a side chain selected from, for example, an alkyl, arylalkyl, dialkyl, ethoxyl, and/or hydrophobic group. In some embodiments, a nonionic monomer may comprise AMD. In some embodiments, nonionic monomers may comprise but are not limited to comprising vinyl amide (e.g., acrylamide, methacrylamide, N-methylacrylamide, N,N-dimethylacrylamide), acryloylmorpholine, acrylate, maleic anhydride, N-vinylpyrrolidone, vinyl acetate, N-vinyl formamide and their derivatives, such as hydroxyethyl (methyl)acrylate CH2=CR—COO—CH2CH2OH (I) and CH2=CR—CO—N(Z1)(Z2) (2) N-substituted (methyl)acrylamide (II). R═H or Me; Z1=5-15C alkyl; 1-3C alkyl substituted by 1-3 phenyl, phenyl or 6-12C cycloalkyl (both optionally substituted) and Z2=H; or Z1 and Z2 are each 3-10C alkyl; (II) is N-tert. hexyl, tert. octyl, methylundecyl, cyclohexyl, benzyl, diphenylmethyl or triphenyl acrylamide. Nonionic monomers may also include N-isopropylacrylamide and N-vinyl formamide. Nonionic monomers can be combined for example form a terpolymer of acrylamide, N-vinyl formamide with anionic acrylic acid.

As used herein, the term “anionic monomers” may refer to either anionic monomers that are substantially anionic in whole or (in equilibrium) in part, at a pH in the range of about 4.0 to about 9.0. The “anionic monomers” may be neutral at low pH (from a pH of about 2 to about 6), or to anionic monomers that are anionic at low pH.

Examples of anionic monomers which may be used herein include but are not limited to those comprising acrylic, methacrylic, maleic monomers and the like, calcium diacrylate, and/or any monomer substituted with a carboxylic acid group or salt thereof. In some embodiments, these anionic monomers may be substituted with a carboxylic acid group and include, for example, acrylic acid, and methacrylic acid. In some embodiments, an anionic monomer which may be used herein may be a (meth)acrylamide monomer wherein the amide group has been hydrolyzed to a carboxyl group. Said monomer may be a derivative or salt of a monomer according to the embodiments. Additional examples of anionic monomers comprise but are not limited to those comprising sulfonic acids or a sulfonic acid group, or both. In some embodiments, the anionic monomers which may be used herein may comprise a sulfonic function that may comprise, for example, acrylamide tertiary butyl sulfonic acid (also known as 2-acrylamido-2-methylpropane sulfonic acid or N-t-butyl acrylamide sulfonic acid) (“ATBS”). In some embodiments, anionic monomers may comprise organic acids. In some embodiments, anionic monomers may comprise acrylic acid, methacrylic acid, maleic acid, itaconic acid, acrylamido methylpropane sulfonic acid, vinylphosphonic acid, styrene sulfonic acid and their salts such as sodium, ammonium and potassium. Anionic monomers can be combined for example to form a terpolymer of acrylamide, acrylic acid and ATBS.

As used herein, the term “cationic monomer” generally refers to a monomer that possesses a positive charge. Examples of cationic monomers may comprise but are not limited to those comprising acryloyloxy ethyl trimethyl ammonium chloride (“AETAC”), methacryloyloxyethyltrimethylammonium chloride, methacryl amidopropyltrimethyl ammonium chloride (“MAPTAC”), acryl amidopropyltrimethylammonium chloride, methacryloyloxyethyldimethylammonium sulfate, dimethylaminoethyl acrylate, dimethylaminopropylmethacrylamide, Q6, Q6o 4, and/or diallyldimethylammonium chloride (“DADMAC”).

Said cationic monomers may also comprise but are not limited to those comprising dialkylaminoalkyl acrylates and methacrylates and their quaternary or acid salts, including, but not limited to, dimethylaminoethyl acrylate methyl chloride quaternary salt (“DMAEA.MCQ”), dimethylaminoethyl acrylate methyl sulfate quaternary salt (“DMAEM.MCQ”), dimethyaminoethyl acrylate benzyl chloride quaternary salt (“DMAEA.BCQ”), dimethylaminoethyl acrylate sulfuric acid salt, dimethylaminoethyl acrylate hydrochloric acid salt, diethylaminoethyl acrylate, methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt, dialkylaminoalkylacrylamides or methacrylamides and their quaternary or acid salts such as acrylamidopropyltrimethylammonium chloride, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethyl aminoethylmethacrylate and diallyldialkylammonium halides such as diallyldiethylammonium chloride and diallyldimethyl ammonium chloride. Alkyl groups may generally but are not limited to those comprising C₁₋₈ alkyl groups. In some embodiments, cationic monomers may comprise quaternary ammonium or acid salts of vinyl amide, vinyl carboxylic acid, methacrylate and their derivatives. Cationic monomers may comprise but are not limited to comprising monomers selected from the group consisting of dimethylaminoethyl acrylate methyl chloride quaternary salt, dimethyl aminoethylmethacrylate methyl chloride quaternary salt, and diallyldimethyl ammonium chloride. Cationic monomers can be combined, for example to form a terpolymer of dimethylaminoethylmethacrylate methyl chloride quaternary salt, and diallyldimethyl ammonium chloride and acrylamide.

As used herein, the terms “polyacrylamide” or “PAM” generally refer to polymers and co-polymers comprising acrylamide moieties, and encompasses any polymers or copolymers comprising acrylamide moieties, e.g., one or more acrylamide (co)polymers. PAMs may be provided in one of various forms, including, for example, dry (powder) form (e.g., DPAM), water-in-oil emulsion (inverse emulsion), suspension, dispersion, or partly hydrolyzed (e.g., HPAM, in which some of the acrylamide units have been hydrolyzed to acrylic acid). PAMs may be used for polymer flooding. Additionally, PAMs may be used in any EOR technique.

As used within, the term “crosslinker” generally refers to the use of an agent capable of creating bonds or crosslinks, e.g., covalent bonds or crosslinks, e.g., ionic bonds or crosslinks, between polymer chains during the polymerization. Some embodiments described herein contemplate the use of a “stable crosslinker”, e.g., inorganic or organic crosslinker, or combination thereof, which is defined as any crosslinker that does not disintegrate under specific conditions, e.g., one which may be added during the polymerization of the re-crosslinkable PPG to produce a PPG which is swellable in water or brine. Organic cross-linkers may comprise methylene bisacrylamide (“MBA”), hexamethylenetetramine, diallylamine, triallylamine, divinyl sulfone, divinyl benzene, allylmethacrylate, diethyleneglycol diallyl ether and/or phenol aldehyde. In some embodiments, said crosslinker may comprise MBA. In some embodiments, a monomer composition of re-crosslinkable PPGs may comprise at least one crosslinker, e.g., a covalent and/or stable crosslinker. In some embodiments, a stable crosslinker may create covalent bonds or crosslinks between polymer chains (“covalent crosslinker”).

As used herein, the term “preformed particle gel” (“PPG”) generally refers to water dispersible polymer particles, typically crosslinked polymer particles that may swell after their addition to an aqueous fluid such as fresh or salt water, brine, produced water, flowback water, and/or brackish water. In some embodiments, PPGs may be prepared by first forming a bulk gel comprising a polymer, copolymer, and/or a terpolymer, such as a polymer and/or copolymer comprising acrylamide monomers and/or acrylic acid monomers and/or a terpolymer comprising acrylamide, acrylic acid, and ATBS, and a crosslinker, such as MBA, and subsequently mechanically processing the gel, e.g., by crushing and/or grinding, to produce particles of a desired size range. In some embodiments, the dried size of PPG particles following mechanical processing may range from about 0.10 micron to about 50 mm in diameter. In some embodiments PPGs may be prepared off-site, then brought to a desired location for use. In typical embodiments PPGs are deformable, which property facilitates their flowing through porous media even when the PPGs are larger than the pore throats.

Generally, dry swellable polymer such as PPG typically contains long parallel chains of molecules that are crosslinked to create a network of polymer chains. In general, the dry swellable polymer may absorb liquid and may increase in volume (swell) when it comes in contact with a fluid, such as water. Water absorption by these crosslinked polymers generally occurs through formation of hydrogen bonds with water molecules. On the other hand, dry linear polymer, such as linear polyacrylamide, is usually soluble in water, but will not be significantly water swellable.

As used herein, “re-crosslinkable PPGs”, “PPGs which may be re-crosslinked,” and the like, refer to PPGs that have a lower degree of crosslinking relative to conventional PPGs such that said re-crosslinkable PPGs, though they are swellable, also comprise a sufficient amount of (uncrosslinked) soluble linear chains to facilitate re-crosslinking. These linear chains are available to facilitate re-crosslinking of PPG particles to bond together, as described herein. In some embodiments, the linear chains comprise at least one carboxylic acid group, e.g., an acrylate group. In some embodiments, re-crosslinkable PPGs possess properties such as size, mechanical strength, swell capacity that permits their use in processes wherein conventional PPGs are used, for example, in enhanced oil recovery processes. As is disclosed herein the re-crosslinkable PPG comprising a decreased degree of cross-linking and which possesses a sufficient amount of soluble linear chains to facilitate re-crosslinking may be produced by different means, such as, but not limited to, the usage of reduced amounts of cross-linker, e.g., reduced amounts of stable crosslinker, e.g., reduced amounts of covalent crosslinker, the usage of less efficient cross-linkers, the usage of specific monomers or monomer combinations, a reduced duration for the cross-linking reaction, and/or the addition of one or more polymers comprising soluble linear chains or any combination of the foregoing. In some embodiments, compositions are provided comprising re-crosslinkable PPGs according to the invention which may be re-crosslinked when contacted with at least one re-crosslinker resulting in re-crosslinked PPGs suitable for use in conformance control. In some embodiments, a composition or compositions are provided which contain re-crosslinkable PPGs according to the invention and at least one re-crosslinker, optionally wherein said composition or compositions are in the same package or in different packages. In some embodiments compositions are provided comprising re-crosslinked PPGs according to the invention which are obtained by contacting re-crosslinkable PPGs according to the invention with at least one re-crosslinker under conditions suitable for re-crosslinking and the formation of re-crosslinked PPGs suitable for use in conformance control.

As used herein, “re-crosslinked PPGs” and the like refer to the re-crosslinkable PPGs that have been re-crosslinked to bond at least some of the soluble linear chains, thereby bonding the PPGs. Upon re-crosslinking, the resultant re-crosslinked PPG may exhibit reduced swell capacity, and increased strength (elongation). Upon re-crosslinking, the resultant re-crosslinked PPG may exhibit increased swell capacity, and increased strength (elongation). In some embodiments, re-crosslinked PPGs possess properties such as size, mechanical strength and swell capacity that permits their use in processes wherein PPGs are used, for example, in enhanced oil recovery processes.

As used herein, the term “re-crosslink” or “recrosslinking” or the like generally refers to a process or method by which re-crosslinkable PPGs may be further crosslinked to bond the (uncrosslinked) linear chains of said PPGs to one another. In some embodiments, re-crosslinking may be slowed and/or prevented by agitation, e.g., mixing, of a composition comprising re-crosslinkable PPGs and a re-crosslinker.

As used herein, the term “re-crosslinker” or “re-crosslinking agent” or the like refers to crosslinking agents that are suitable for the re-crosslinking, described herein. In some embodiments, re-crosslinking agents form bonds with the carboxylic acid groups in the linear polymer chains of the re-crosslinkable PPG. In some embodiments, a re-crosslinking agent may comprise a water soluble crosslinker, such as transition metals, organics, and/or borates. Re-crosslinkers can include borate sources, such as boronic acid, boronate ester, and/or sodium tetraborate or sodium tetraborate decahydrate, and the like. Re-crosslinkers can include multivalent metal crosslinking agents such as Al⁺³, Fe⁺³, Fe⁺², Cr⁺³, Zr⁺⁴, Ti⁺⁴, Cu⁺², Sr⁺², Zn⁺², W⁺², Sb⁺⁵ and combinations and salts thereof such as acetates, nitrates, phosphates, carbonates, propionates, benzoates, formates, citrates and the like, which may act as “ionic crosslinkers”. Inorganic re-crosslinkers can include aluminum salt, e.g., aluminum chloride; chromium salt, e.g., chromium acetate, zirconium salt, e.g., zirconium acetate; iron salt, e.g., ferric chloride; titanium salt; and chromium salt. Organic re-cross-linkers may comprise phenol, polyethyleneimine (“PEI”) and formaldehyde. Re-crosslinkers can further include any one or more of the multivalent Group III-Group VII transition metal molecules, and combinations and salts thereof, which may act as “ionic crosslinkers”. In some embodiments, a re-crosslinking agent may comprise one or more polysaccharides. In some embodiments, the re-crosslinker may comprise a combination or blend of one or more crosslinkers. In some embodiments, a re-crosslinking agent may be any transitional multivalent ion. In some embodiments, a re-crosslinking agent may be added to re-crosslinkable PPGs before, during, and/or after swelling. In some embodiments, a re-crosslinking agent may be provided in the same package as one or more re-crosslinkable PPGs. In some embodiments, a re-crosslinking agent may be provided in a different package as one or more re-crosslinkable PPGs. In some embodiments the “re-crosslinker”may comprise a “stable re-crosslinker”, which is defined as any re-crosslinker, e.g., as above-described that does not disintegrate under specific conditions, e.g., one which may be added during re-crosslinking of re-crosslinkable PPGs according to the invention in specific environments such as those where conformance control is desired, e.g., the “stable re-crosslinker” is one which is stable in water or brine.

As used herein, the term “thief zone” generally refers to zones within a reservoir into which injected water may preferentially enter over a comparably lower permeability zone and said preferential entry may result in the injected water not reaching unswept zones. As such, a thief zone may be a pore, channel, and/or void into which water and/or other injected materials may enter in an undesirable manner. In some embodiments, re-crosslinkable PPGs may themselves enter thief zones, subsequently be re-crosslinked, and as a result of said re-crosslinking, said PPGs may block the undesired entry of water and/or other injected materials during enhanced oil recovery.

As used herein, the term “conformance control” generally refers to any process by which the sweeping of a reservoir may be spread more evenly.

As used herein, the term “conformance control agent” generally refers to any material, technique, method, and/or process that may be used to effect conformance control.

As used herein, the term “sweep efficiency” generally refers to a measure of the effectiveness of an enhanced oil recovery process that may depend on the volume of the reservoir contacted by the injected fluid.

As used herein, the term “swell capacity” generally refers to the amount of liquid material that may be absorbed by a composition, such as PPGs and/or re-crosslinkable PPGs and/or re-crosslinked PPGs. In some embodiments, the swell capacity may be determined by adding an amount of sample, for instance, 0.5 g of sample, to a graduated container containing 99.5 g of brine or other aqueous fluid. The polymer is permitted to swell for a specified period of time, and the volume of the swollen polymer is measured. The swell capacity may then be determined by dividing the measured swollen volume by the initial (unswollen) sample volume. Particles, such as, for example, re-crosslinkable PPGs, that are “swellable”, generally comprise a swell capacity greater than 1.0.

As used herein, the term “elongation” generally refers to the ability of a material, such as re-crosslinked PPGs that have bonded together, to be stretched. An elongation value may be calculated by measuring the initial length of a material, and then stretching said material along its length until it breaks. The length at which the material breaks may be noted, and then divided by the initial length to provide an elongation value.

As used herein, the term “brittle” generally refers to the ability of a material, such as re-crosslinked PPGs, to be weakly bonded, but the bond breaks under stress.

As used herein, the term “enhanced oil recovery” or “EOR” (sometimes also known as improved oil recovery (“IOR”) or tertiary mineral oil production) generally refers to techniques for increasing the amount of unrefined petroleum (for example, crude oil) that may be extracted from an oil reservoir, such as an oil field. Examples of EOR techniques include, for example, miscible gas injection (e.g., carbon dioxide flooding), chemical injection (sometimes referred to as chemical enhanced oil recovery (“CEOR”), and which includes, for example, polymer flooding, alkaline flooding, surfactant flooding, micellar polymer flooding, conformance control operations, as well as combinations thereof such as alkaline-polymer flooding or alkaline-surfactant-polymer flooding), microbial injection, and thermal recovery (e.g., cyclic steam, steam flooding, or fire flooding). In some embodiments, the EOR operation may include a polymer (“P”) flooding operation, an alkaline-polymer (“AP”) flooding operation, a surfactant-polymer (“SP”) flooding operation, an alkaline-surfactant-polymer (“ASP”) flooding operation, a conformance control operation, or any combination thereof.

As used herein, the terms “polymer flood” or “polymer flooding” generally refer to a chemical enhanced EOR technique that typically involves injecting an aqueous fluid that is viscosified with one or more water-soluble polymers through injection boreholes into an oil reservoir to mobilize oil left behind after primary and/or secondary recovery. As a general result of the injection of one or more polymers, the oil may be forced in the direction of the production borehole, and the oil may be produced through the production borehole. Details of polymer flooding and of polymers suitable for this purpose are disclosed, for example, in “Petroleum, Enhanced Oil Recovery, Kirk-Othmer, Encyclopedia of Chemical Technology, online edition, John Wiley & Sons, 2010”, which is herein incorporated by reference in its entirety.

One or more surfactants may be injected (or formed in situ) as part of the EOR technique. Surfactants may function to reduce the interfacial tension between the oil and water, which may reduce capillary pressure and improve mobilization of oil. Surfactants may be injected with polymers, for example, in a surfactant-polymer flood or formed in-situ for example, in an alkaline-polymer (AP) flood, or a combination thereof, such as, for example, an alkaline-surfactant-polymer flood (ASP). As used herein, the terms “polymer flood” and “polymer flooding” encompass all of these EOR techniques.

As used herein, the term “produced water” generally refers to any aqueous fluids produced during any type of industrial process, e.g., an oil or gas extraction or recovery process, or any portion thereof, such as but not limited to any enhanced oil recovery process or any portion thereof wherein the produced water comprises one or more polymers, e.g., one or more water-soluble polymers. Typically the produced water may be obtained during an industrial process involving the use of water, generally copious amounts of water, and the use of one or more water soluble polymers, e.g., viscosifying or thickening polymers, wherein the end product of such industrial process may be an aqueous material or “produced water” which may be of undesirable viscosity and/or purity because of the presence of an undesirable amount of said one or more water soluble polymers.

PPGs, and Compositions and Methods Comprising the Use Thereof

The present invention provides one or more re-crosslinkable PPGs which when contacted with at least one re-crosslinker result in re-crosslinked PPGs having enhanced conformance properties. In some embodiments, one or more re-crosslinkable PPGs described herein may be re-crosslinked when contacted with at least one re-crosslinker, wherein the use thereof in methods and processes such as EOR processes provides for a substantial improvement in relation to conventional PPGs and methods of using same. Particularly, under certain conditions, conventional PPGs may be removed from pores or voids under pressure or may not be able to fill larger pores, wormholes, or voids. Also, conventional PPGs are generally not amenable to re-crosslinking (as described herein). By contrast the re-crosslinkable PPGs disclosed herein may readily be re-crosslinked to each other, i.e., further crosslinked to bond the (uncrosslinked) linear chains of said PPGs to one another, and are capable of forming a strong and flexible gel when re-crosslinked which, in comparison to conventional PPGs, should be able to better withstand pressure and remain for more prolonged duration in the pores or voids of a subterranean formation.

Generally, conventional PPGs are formed by polymerization of one or more monomers. During crosslinking of the polymer, the PPG is crosslinked with at least one crosslinker, such as MBA. The resultant PPG is capable of swelling in water or aqueous fluids. According to some embodiments, a re-crosslinkable PPG is formed similarly to a conventional PPG. However, in contrast to conventional PPGs the level of cross-linking of the re-crosslinkable PPG is decreased so that the resulting re-crosslinkable PPG contains some soluble linear chains which provide for re-crosslinking. In some embodiments, a re-crosslinkable PPG has these soluble linear chains, which can be re-crosslinked using known types of re-crosslinkers, as described herein.

In some embodiments, re-crosslinkable PPGs may comprise polymers comprising any of the monomers described herein. In some embodiments, re-crosslinkable PPGs may comprise polymers comprising nonionic, anionic, and/or cationic monomers. In some embodiments, the polymer may comprise a nonionic polymer that is later hydrolyzed to comprise carboxylate groups. In some embodiments, hydrolyzation can be produced by heat, adding metal or ammonium hydroxides or sodium carbonate.

In some embodiments, said re-crosslinkable PPGs may comprise polymer(s) comprising acrylamide and/or acrylic acid. In some embodiments, the percentage of acrylamide in the polymer comprises 1% or less, 1% or more, 10% or more, 20% or more, 30% or more, 40% or more, 50% or more, 60% or more, 70% or more, 80% or more, 90% or more, or 99% or more. In some embodiments, the percentage of acrylic acid in the polymer comprises 1% or less, 1% or more, 10% or more, 20% or more, 30% or more, 40% or more, 50% or more, 60% or more, 70% or more, 80% or more, 90% or more, 99% or more, or 100%. In some embodiments, said re-crosslinkable PPGs may comprise polymer(s) comprising acrylamide and acrylic acid, wherein say re-crosslinkable PPGs comprise 1% acrylic acid and 99% acrylamide; 10% acrylic acid and 90% acrylamide; 55% acrylic acid and 45% acrylamide; 70% acrylic acid and 30% acrylamide; or 90% acrylic acid and 10% acrylamide.

In some embodiments, said re-crosslinkable PPGs may comprise polymer(s) comprising acrylamide and ATBS. In some embodiments, the percentage of acrylamide in the polymer comprises 1% or less, 1% or more, 10% or more, 20% or more, 30% or more, 40% or more, 50% or more, 60% or more, 70% or more, 80% or more, 90% or more, or 99% or more. In some embodiments, the percentage of ATBS in the polymer comprises 1% or less, 1% or more, 10% or more, 20% or more, 30% or more, 40% or more, 50% or more, 60% or more, 70% or more, 80% or more, 90% or more, 99% or more, or 100%. In some embodiments, said re-crosslinkable PPGs may comprise polymer(s) comprising acrylamide and ATBS, wherein the percentage of ATBS in the polymer may be 10% and the percentage of acrylamide in the polymer may be 90%.

In general, increasing the degree of crosslinking may increase the strength of an individual PPG particle, but may decrease the swelling ability, i.e., an inverse relationship has been observed between strength and swelling ability. Conversely, reducing the degree of crosslinking to a lower level may result in a corresponding reduction in individual PPG particle strength. However, re-crosslinking the linear chains of re-crosslinkable PPGs may allow bonding of the re-crosslinkable PPG particles and increase the viscoelastic strength of the resulting re-crosslinked PPG gel. For example, at lower degree(s) of crosslinking, where there are more soluble linear chains, swelling ability will be reduced in some instances. However, in some instances, a lower degree of crosslinking may increase swelling ability. For example, in some instances, re-crosslinkable PPGs comprising acrylamide and acrylic acid, such as 90% acrylamide and 10% acrylic acid, may comprise a higher value of swell capacity for crosslinker levels of between 10 ppm to about 45 ppm as compared to re-crosslinkable PPGs comprising acrylamide and acrylic acid where the crosslinker level is about 100 ppm or more. Furthermore, for example, in some instances, re-crosslinkable PPGs comprising acrylamide and acrylic acid, such as 70% acrylamide and 30% acrylic acid, may comprise a higher value of swell capacity for crosslinker levels of between 15 ppm to about 35 ppm as compared to re-crosslinkable PPGs comprising acrylamide and acrylic acid where the crosslinker level is about 100 ppm or more. In some embodiments, re-crosslinkable PPGs or compositions containing re-crosslinkable PPGs may comprise a decreased level of crosslinking which results in increased swell capacity and increased strength (elongation) upon the addition of a re-crosslinker and/or re-crosslinking of the re-crosslinkable PPG particles to bond the re-crosslinkable PPG particles together according to some embodiments. For example, in some instances, e.g., dependent upon the particular brine conditions, re-crosslinkable PPGs comprising acrylamide and acrylic acid, e.g., re-crosslinkable PPGs comprising 90% acrylamide and 10% acrylic acid, may comprise a higher value of swell capacity for crosslinker levels of between 10 ppm to about 45 ppm as compared to re-crosslinkable PPGs comprising acrylamide and acrylic acid where the crosslinker level is higher, e.g., about 100 ppm or more. This may occur because for a given re-crosslinkable PPG composition the particular brine conditions where the re-crosslinkable PPGs are present may impact the crosslinker levels for which swell capacity is maximal (i.e., for a particular re-crosslinkable PPG composition). This variability may be taken into account by assaying swell capacity of different re-crosslinkable PPG compositions according to the invention under different brine conditions, including the brine conditions of the environment where the re-crosslinkable PPGs are to be used in conformance control. Similarly, in some instances, e.g., under certain brine conditions, re-crosslinkable PPGs comprising acrylamide and acrylic acid, such as 70% acrylamide and 30% acrylic acid, may comprise a higher value of swell capacity for crosslinker levels of between 15 ppm to about 35 ppm as compared to re-crosslinkable PPGs comprising acrylamide and acrylic acid where the crosslinker level is about 100 ppm or more. Again this may occur because for a given re-crosslinkable PPG composition the particular brine conditions may impact the crosslinker levels for which swell capacity is maximal; however this variability may be taken into account by assaying swell capacity of re-crosslinkable PPG compositions according to the invention under different brine conditions, including the brine conditions of the environment where the particular re-crosslinkable PPGs are to be used in conformance control. Furthermore, the decrease in crosslinker level which results in increased swell capacity and increased strength (elongation) may also be due in part to the presence of increasing amounts of soluble linear chains.

In some embodiments, re-crosslinkable PPGs may be unswollen, partially swollen, or substantially swollen topside prior to introduction and/or injection into one or more desired locations. For example, embodiments, re-crosslinkable PPGs may be unswolleng, partially swollen, or substantially swollen above the surface in a chosen environment (brine, salinity, temperature and pH), thereby promoting user control of swell and elongation.

Various methods may be used to decrease the degree of crosslinking in a re-crosslinkable PPG. For example, one may make a PPG according to a conventional method, but with a decreased amount of crosslinker in the monomer mixture, thereby producing a re-crosslinkable PPG. In some embodiments, a cross-linked conventional PPG may be mixed or blended with a dried polyacrylamide (DPAM), which is a linear (uncrosslinked) polymer. In some embodiments, a blend may comprise 5 parts or less, 5 parts or more, 10 parts or more, 15 parts or more, 20 parts or more (of 100 parts) of the crosslinked conventional PPG. In some embodiments, a blend may comprise 10 parts or less, 10 parts or more, 15 parts or more, 20 parts or more (of 100 parts) of said linear DPAM polymer. In some embodiments, a linear DPAM may be dissolved in a conventional PPG monomer solution containing a crosslinker and polymerized under reaction conditions effective to form a double polymer network comprising some soluble linear chains.

Under suitable conditions (for example, by controlling polymer solids, particle size, brine, temperature, pH, and/or time) a linear particle may behave like a PPG, i.e., said particle may exhibit swelling and may not dissolve into solution, thereby allowing re-crosslinking to take place. In some embodiments, under such conditions, a re-crosslinkable PPG may comprise 0 ppm on monomer of a crosslinker, and said PPG may still re-crosslink, thereby forming a swellable composition that is capable of elongation. In some embodiments, under such conditions, a re-crosslinkable PPG may comprise 0 ppm of a crosslinker, and said PPG may still re-crosslink, thereby forming a swellable composition that is capable of elongation. One having ordinary skill in the art would understand these and other suitable methods that one could use to prepare a re-crosslinkable PPG as described herein.

In some embodiments, the monomer composition of a re-crosslinkable PPG may comprise a crosslinker. In some embodiments, said crosslinker may comprise MBA. In some embodiments, said crosslinker may comprise an organic cross-linker. Organic cross-linkers may comprise MBA, hexamethylenetetramine, diallylamine, triallylamine, divinyl sulfone, diethyleneglycol diallyl ether, divinyl benzene, allyl methacrylate and/or phenol aldehyde. In some embodiments, a re-crosslinkable PPG monomer composition may comprise MBA, and said MBA may comprise a concentration of 0.1 ppm or less, 0.5 ppm or less, 1.0 ppm or less, 2.0 ppm or less, 3.0 ppm or less, 4.0 ppm or less, 5.0 ppm or less, 6.0 ppm or less, 7.0 ppm or less, 8.0 ppm or less, 9.0 ppm or less, 10.0 ppm or less, 12.5 ppm or less, 15.0 ppm or less, 17.5 ppm or less, 20.0 ppm or less, 22.5 ppm or less, 25.0 ppm or less, 27.5 ppm or less, 30.0 ppm or less, 32.5 ppm or less, 35.0 ppm or less, 37.5 ppm or less, 40.0 ppm or less, 42.5 ppm or less, 45.0 ppm or less, 47.5 ppm or less, 50.0 ppm or less, 52.5 ppm or less, 55.0 ppm or less, 57.5 ppm or less, 60.0 ppm or less, 62.5 ppm or less, 65.0 ppm or less, 67.5 ppm or less, 70.0 ppm or less, 72.5 ppm or less, 75.0 ppm or less, 77.5 ppm or less, 80.0 ppm or less, 82.5 ppm or less, 85.0 ppm or less, 87.5 ppm or less, 90.0 ppm or less, 92.5 ppm or less, 95.0 ppm or less, 97.5 ppm or less, or 100.0 ppm or less in the polymer. In some embodiments, said PPGs monomer composition may comprise 100 ppm or less on monomer of MBA. In some embodiments, a re-crosslinkable PPG monomer composition may comprise MBA, and said MBA may comprise a concentration of 8 ppm, 12 ppm, or 50 ppm. In some embodiments, said crosslinker may comprise a stable crosslinker. In some embodiments, a crosslinker may comprise a covalent crosslinker.

In some embodiments, the re-crosslinkable PPG is re-crosslinked so that least some of the linear polymer chains in the re-crosslinkable PPG are bonded, thereby forming a re-crosslinked PPG. According to the various embodiments, the re-crosslinking agent may be added when the re-crosslinkable PPG is in an unswollen, partially swollen, or substantially swollen state. In some embodiments, re-crosslinking may occur after re-crosslinkable PPGs and at least one re-crosslinker have been introduced or injected into a desired structure, e.g., a structure comprising pores, voids, and/or channels. Re-crosslinking may be effected using any suitable re-crosslinking agent, such as those described herein.

In some embodiments, re-crosslinking of said re-crosslinkable PPGs may be effected in a desired time period, e.g., a few days. In some embodiments, re-crosslinking of said PPGs may occur in 1 day or less, 1 day or more, 2 days or more, 3 days or more, 4 days or more, 5 days or more, 6 days or more, 7 days or more, 8 days or more, 9 days or more, or 10 days or more.

In some embodiments, re-crosslinking of said re-crosslinkable PPGs may occur at room temperature. In some embodiments, said re-crosslinkable PPGs may be re-crosslinked at temperatures ranging from 4° C. to 150° C.

In some embodiments, re-crosslinking of said re-crosslinkable PPGs may be achieved over a wide range of pH values. In some embodiments, re-crosslinking of the re-crosslinkable PPGs may occur at neutral pH. In some embodiments, said re-crosslinkable PPGs may be re-crosslinked in the presence of pH stabilizers or pH modifiers.

According to the various embodiments, the resultant re-crosslinked PPG may have any necessary or desired strength from bonding of the re-crosslinkable PPG particles. For example, in some embodiments, the re-crosslinked PPG may be a relatively strong, flexible viscoelastic gel. In further embodiments, the resultant re-crosslinked PPG may have weaker or more brittle re-crosslinking bonds. In some embodiments, re-crosslinked PPGs may be able to withstand pressure and remain in pores or voids when conventional PPGs may be displaced under similar conditions, e.g., similar pressure conditions.

In some embodiments, the monomer composition of the re-crosslinkable PPGs may comprise one or more components other than the linear polymer chains that may be re-crosslinked with a re-crosslinking agent. Components may include, for example: one or more initiators, such as, but not limited to ammonium persulfate, potassium persulfate, sodium persulfate, sodium bromate, sodium sulfite, potassium sulfite or mixture, and 2,2′-azobis(2-methylpropiopionitrile); peroxides such as, but not limited to t-butyl peroxide, benzoyl peroxide, diidopropylbenzene peroxide, azobisisobutyronitrile, optionally with bases, such as, but not limited to sodium carbonate, sodium bicarbonate, sodium hydroxide; reducing promoters, such as, but not limited to potassium metabisulfite, sodium sulfite, thionyl chloride, thionyl bromide; regulators such as, but not limited to alcohols; stabilizers, such as, but not limited to phenol, m-dihydroxybenzene, hydroquinone; chelating agents such as, but not limited to ethylene diamine tetra acetate (EDTA) and diethylenetriamine pentaacetate (DTPA); thermal agents such as, but not limited to 2-acrylamido-2-methyl propane sulfonic acid; chain-transfer agents, such as, but not limited to thiols such as dodecyl mercaptan, formic acid and alkali metal formates such as sodium formate; oxygen scavengers such as, but not limited to sodium sulfite, sodium bisulfite, sodium thiosulfate, sodium lignosulfate, ammonium bisulfite, hydroquinone, diethylhydroxyethanol, diethylhydroxylamine, methylethylketoxime, ascorbic acid, erythorbic acid, and sodium erythorbate; pH adjusters such as, but not limited to sodium, ammonium or potassium hydroxide; and/or gel strength, thermal and chemical resistance modifiers, such as, but not limited to bentonite, lignocellulose, clay, laponite, montnorillonite, diatomite, kaolinoite, titania, silica, silicates and other fillers, or combinations or mixtures thereof.

In some embodiments, inhibitors may be added, such as, but not limited to, sodium citrate, sodium lactate, sodium acetate, acetic acid and the like to deaccelerate the re-crosslinking rate.

In some embodiments, the re-crosslinking may be accelerated using one or more chemical additives for re-crosslinking acceleration, for example, chromic trichloride may be added. In some embodiments, buffering agents, such as sodium bicarbonate and the like, may be added to pH buffer the treatment fluid.

In some embodiments, re-crosslinking of said re-crosslinkable PPGs may be achieved over a wide range of initial re-crosslinkable PPG particle sizes. In some embodiments, the subject re-crosslinkable PPGs may comprise any diameter that is suitable to obtain a desirable result in a method or process, such as their usage in EOR techniques, methods, and processes. In some embodiments, said re-crosslinkable PPGs, either in dry form or in swollen form, may comprise a diameter of 0.10 μm or less, 0.5 μm or less, 1.0 μm or less, 10.0 μm or less, 50.0 μm or less, 0.1 mm or less, 0.15 mm or less, 0.20 mm or less, 0.25 mm or less, 0.30 mm or less, 0.35 mm or less, 0.40 mm or less, 0.45 mm or less, 0.50 mm or less, 0.55 mm or less, 0.60 mm or less, 0.65 mm or less, 0.70 mm or less, 0.75 mm or less, 0.80 mm or less, 0.90 mm or less, 0.95 mm or less, 1.00 mm or less, 1.10 mm or less, 1.20 mm or less, 1.30 mm or less, 1.40 mm or less, 1.50 mm or less, 1.60 mm or less, 1.70 mm or less, 1.80 mm or less, 1.90 mm or less, 2.00 mm or less, 2.25 mm or less, 2.50 mm or less, 2.75 mm or less, 3.00 mm or less, 3.25 mm or less, 3.50 mm or less, 3.75 mm or less, 4.00 mm or less, 4.25 mm or less, 4.50 mm or less, 4.75 mm or less, 5.00 mm or less, 6.00 mm or less, 7.00 mm or less, 8.00 mm or less, 9.00 mm or less, 10.00 mm or less, 11.00 mm or less, 12.00 mm or less, 13.00 mm or less, 14.00 mm or less, 15.00 mm or less, 16.00 mm or less, 17.00 mm or less, 18.00 mm or less, 19.00 mm or less, 20.00 mm or less, 25.00 mm or less, 30.00 mm or less, 35.00 mm or less, 40.00 mm or less, 45.00 mm or less, 50.00 mm or less, or 50.00 mm or more. In some embodiments, said re-crosslinkable PPGs in dry form may comprise a diameter of 0.10 m or less, 0.5 m or less, 1.0 m or less, 10.0 m or less, 50.0 m or less, 0.1 mm or less, 0.15 mm or less, 0.20 mm or less, 0.25 mm or less, 0.30 mm or less, 0.35 mm or less, 0.40 mm or less, 0.45 mm or less, 0.50 mm or less, 0.55 mm or less, 0.60 mm or less, 0.65 mm or less, 0.70 mm or less, 0.75 mm or less, 0.80 mm or less, 0.90 mm or less, 0.95 mm or less, 1.00 mm or less, 1.10 mm or less, 1.20 mm or less, 1.30 mm or less, 1.40 mm or less, 1.50 mm or less, 1.60 mm or less, 1.70 mm or less, 1.80 mm or less, 1.90 mm or less, 2.00 mm or less, 2.25 mm or less, 2.50 mm or less, 2.75 mm or less, 3.00 mm or less, 3.25 mm or less, 3.50 mm or less, 3.75 mm or less, 4.00 mm or less, 4.25 mm or less, 4.50 mm or less, 4.75 mm or less, 5.00 mm or less, 6.00 mm or less, 7.00 mm or less, 8.00 mm or less, 9.00 mm or less, 10.00 mm or less, 11.00 mm or less, 12.00 mm or less, 13.00 mm or less, 14.00 mm or less, 15.00 mm or less, 16.00 mm or less, 17.00 mm or less, 18.00 mm or less, 19.00 mm or less, 20.00 mm or less, 25.00 mm or less, 30.00 mm or less, 35.00 mm or less, 40.00 mm or less, 45.00 mm or less, 50.00 mm or less, or 50.00 mm or more. In some embodiments, said re-crosslinkable PPGs in swollen form may comprise a diameter of 0.10 m or less, 0.5 m or less, 1.0 m or less, 10.0 m or less, 50.0 m or less, 0.1 mm or less, 0.15 mm or less, 0.20 mm or less, 0.25 mm or less, 0.30 mm or less, 0.35 mm or less, 0.40 mm or less, 0.45 mm or less, 0.50 mm or less, 0.55 mm or less, 0.60 mm or less, 0.65 mm or less, 0.70 mm or less, 0.75 mm or less, 0.80 mm or less, 0.90 mm or less, 0.95 mm or less, 1.00 mm or less, 1.10 mm or less, 1.20 mm or less, 1.30 mm or less, 1.40 mm or less, 1.50 mm or less, 1.60 mm or less, 1.70 mm or less, 1.80 mm or less, 1.90 mm or less, 2.00 mm or less, 2.25 mm or less, 2.50 mm or less, 2.75 mm or less, 3.00 mm or less, 3.25 mm or less, 3.50 mm or less, 3.75 mm or less, 4.00 mm or less, 4.25 mm or less, 4.50 mm or less, 4.75 mm or less, 5.00 mm or less, 6.00 mm or less, 7.00 mm or less, 8.00 mm or less, 9.00 mm or less, 10.00 mm or less, 11.00 mm or less, 12.00 mm or less, 13.00 mm or less, 14.00 mm or less, 15.00 mm or less, 16.00 mm or less, 17.00 mm or less, 18.00 mm or less, 19.00 mm or less, 20.00 mm or less, 25.00 mm or less, 30.00 mm or less, 35.00 mm or less, 40.00 mm or less, 45.00 mm or less, 50.00 mm or less, 75.00 mm or less, 100.00 mm or less, or 100.00 mm or more. In some embodiments, re-crosslinkable PPGs of a desired diameter may be prepared by sieving re-crosslinkable PPG particles to provide re-crosslinkable PPG particles of a desired size range.

In some embodiments, the subject re-crosslinkable and/or re-crosslinked PPGs may comprise a swell capacity of 10.0 or less, 10.0 or more, 12.5 or more, 15.0 or more, 17.5 or more, 20.0 or more, 22.5 or more, 25.0 or more, 27.5 or more, 30.0 or more, 32.5 or more, 35.0 or more, 37.5 or more, 40.0 or more, 42.5 or more, 45.0 or more, 47.5 or more, 50.0 or more, 52.5 or more, 55.0 or more, 57.5 or more, 60.0 or more, 62.5 or more, 65.0 or more, 67.5 or more, 70.0 or more, 72.5 or more, 75.0 or more, 77.5 or more, 80.0 or more, 82.5 or more, 85.0 or more, 87.5 or more, 90.0 or more, 92.5 or more, 95.0 or more, 97.5 or more, 100.0 or more, 105.00 or more, 110.00 or more, 115.00 or more, 120.00 or more, 125.00 or more, 130.00 or more, 135.00 or more, 140.00 or more, 145.00 or more, 150.00 or more, 155.00 or more, 160.00 or more, 165.00 or more, 170.00 or more, 175.00 or more, 180.00 or more, 185.00 or more, 190.00 or more, 195.00 or more, or 200.00 or more.

It has been observed that decreasing the level of crosslinking in the monomer composition will increase the swell capacity for re-crosslinkable PPGs. For example, in some instances, e.g., dependent upon the particular brine conditions, re-crosslinkable PPGs comprising acrylamide and acrylic acid, e.g., re-crosslinkable PPGs comprising 90% acrylamide and 10% acrylic acid, may comprise a higher value of swell capacity for crosslinker levels of between 10 ppm to about 45 ppm as compared to re-crosslinkable PPGs comprising acrylamide and acrylic acid where the crosslinker level is higher, e.g., about 100 ppm or more. This may occur because for a given re-crosslinkable PPG composition the particular brine conditions where the re-crosslinkable PPGs are present may impact the crosslinker levels for which swell capacity is maximal (i.e., for a particular re-crosslinkable PPG composition). This variability may be taken into account by assaying swell capacity of different re-crosslinkable PPG compositions according to the invention under different brine conditions, including the brine conditions of the environment where the re-crosslinkable PPGs are to be used in conformance control. Similarly, in some instances, e.g., under certain brine conditions, re-crosslinkable PPGs comprising acrylamide and acrylic acid, such as 70% acrylamide and 30% acrylic acid, may comprise a higher value of swell capacity for crosslinker levels of between 15 ppm to about 35 ppm as compared to re-crosslinkable PPGs comprising acrylamide and acrylic acid where the crosslinker level is about 100 ppm or more.

In some embodiments, re-crosslinkable PPGs are produced by a polymerization process which includes the addition of a covalent crosslinking agent. In some embodiments, re-crosslinkable PPGs are produced by a polymerization process which does not include an ionic crosslinking agent.

In some instances, when the level of crosslinking is decreased further to produce more soluble linear chains in the polymer, swell capacity may decrease until a certain level of decreased crosslinking is attained. Also, the soluble linear chain portion of the polymer may not swell or swell as much. Further, in some instances above this level that results in decreased swelling, lower levels of crosslinking may promote high viscoelastic strength as this level of crosslinking may provide for the addition of a re-crosslinker which bonds the re-crosslinkable PPG particles together thereby providing a desired viscoelastic strength.

In some embodiments, re-crosslinkable PPGs once re-crosslinked may comprise an elongation value of 2.0 or less, 2.0 or more, 2.5 or more, 3.0 or more, 3.5 or more, 4.0 or more, 4.5 or more, 5.0 or more, 5.5 or more, 6.0 or more, 6.5 or more, 7.0 or more, 7.5 or more, 8.0 or more, 8.5 or more, 9.0 or more, 9.5 or more, or 10.0 or more after re-crosslinking.

Furthermore, the present embodiments generally relate to a composition suitable for use in conformance control comprising: (i) one or more re-crosslinkable, swellable preformed particle gels (“PPGs”) that are suitable for use as a conformance control agent, wherein said re-crosslinkable PPGs are dispersible in water and comprise soluble linear chains which facilitate re-crosslinking; and (ii) at least one re-crosslinker which is suitable for converting the one or more re-crosslinkable PPGs into a viscoelastic gel.

In some embodiments, the re-crosslinker may be added as a solid to a dry re-crosslinkable PPG and mixed or blended. In some embodiments, the re-crosslinker may be added as a liquid and dried on the re-crosslinkable PPG. In some embodiments, the re-crosslinkable PPG may be further ground. Addition of a re-crosslinker to re-crosslinkable PPG as a solid, liquid, or further grinding of re-crosslinkable PPG may allow for a one package PPG. The re-crosslinkable PPG with re-crosslinker already added, as described herein, may then be added to water or brine, which may result in swelling and formation of a viscoelastic gel.

In some embodiments, said composition may further comprise one or more of a surfactant, an aqueous liquid, a fluid comprising at least one of water, an organic solvent, and an oil, a buffer, a mobility buffer, a drive fluid, or another viscosifier. In some embodiments, said re-crosslinker may be added before, during, and/or after swelling of said re-crosslinkable PPG. In general, said composition generally relates to any composition comprising any of the re-crosslinkable PPGs and/or re-crosslinked PPGs as described herein.

Also, the present embodiments generally relate to any method and/or system that comprises the use of any swellable and re-crosslinkable PPG and/or re-crosslinked PPG as described herein, for applications related to and such as enhanced oil recovery. For example, a system for use in conformance control may comprise (i) one or more re-crosslinkable, swellable PPGs suitable for use as a conformance control agent; (ii) at least one re-crosslinker; and (iii) a subterranean formation having the composition therein. In some embodiments, the one or more re-crosslinkable PPGs are converted into a gel during use as a conformance control agent. Said system may further comprise a fluid conduit disposed in an injection wellbore, and/or a pump configured to pump the composition through the conduit downhole.

In some embodiments, one or more re-crosslinkable PPGs in association with at least one re-crosslinker and/or re-crosslinked PPGs may be used in an enhanced oil recovery technique that may primarily target bypassed oil. In some embodiments, said PPGs may be added to injection water for waterflooding and/or polymer flooding. In some embodiments, said PPGs may serve as water-shutoff, conformance control, and/or mobility control agents. In some embodiments, said PPGs may divert injected fluid away from thief zones and into adjacent matrix rock or low-permeability zones, thereby increasing macroscopic sweep efficiency and improving hydrocarbon recovery. In some embodiments, use of re-crosslinkable PPGs in association with at least one re-crosslinker and/or re-crosslinked PPGs in EOR processes may result in a decrease in water production in water and gas shutoff, fluid loss control, zone abandonment, water and gas coning, squeeze and recompletion, chemical liner completions and lost circulation during drilling operations and plugging during drilling and drilling completion.

In some embodiments, compositions and methods comprising re-crosslinkable PPGs in association with at least one re-crosslinker and/or re-crosslinked PPGs may be used in conjunction with enhanced oil recovery techniques and processes. Said PPGs may improve the overall macroscopic sweep efficiency, may improve and/or increase hydrocarbon production, and may decrease associated water production. Said PPGs may generally be used for in processes and techniques related to conformance control as a conformance control agent. Also, said PPGs may generally comprise permeability reduction capabilities and may enable the strategic plugging of high-permeability channels. Said plugging may divert flooding fluid to relatively unswept adjacent low-permeability zones.

Additionally, in some embodiments, a method of conformance control may comprise adding an amount of one or more swellable and re-crosslinkable preformed particle gels (“PPGs”) as described herein which in association with at least one re-crosslinker is effective to act as a conformance control agent, wherein said one or more re-crosslinkable PPGs comprise a decreased degree and/or level of crosslinking (as compared to conventional PPGs) and a sufficient amount of soluble linear chains to facilitate re-crosslinking. As is disclosed herein these re-crosslinkable PPG comprising a decreased degree of cross-linking and which possesses a sufficient amount of soluble linear chains to facilitate re-crosslinking may be produced by different means, such as, but not limited to, the usage of reduced amounts of cross-linker, the usage of less efficient cross-linkers, the usage of specific monomers or monomer combinations, a reduced duration for the cross-linking reaction, and/or the addition of one or more polymers comprising soluble linear chains or any combination of the foregoing.

Re-crosslinkable PPGs in association with at least one re-crosslinker and/or re-crosslinked PPGs may be used as a part of any method and/or process related to enhanced oil recovery and/or conformance control. Said PPGs may be used as a part of methods and/or processes involving conformance control, water shutoff, drill fluids, and/or permeability control. Said PPGs may be used as a part of any method and/or process wherein conventional PPGs may generally be used. Said PPGs may be used in methods for improving production from an oil or gas well, wherein said methods may comprise: (i) providing a formulation comprising re-crosslinkable PPGs comprising soluble linear chains that permit re-crosslinking and/or bonding of the PPGs and a re-crosslinker or a composition as described herein, and delivering the formulation into the oil or gas well, whereby the formulation improves production from the well. Said PPGs may be used in methods for water blocking or water shutoff in an oil or gas well, wherein said methods comprise (i) providing a formulation comprising re-crosslinkable PPGs comprising soluble linear chains that permit re-crosslinking and/or bonding of the PPGs and a re-crosslinker or a composition as described herein, and (ii) delivering the formulation into the oil or gas well, whereby the formulation provides water blocking or water shutoff in the well.

Moreover, the re-crosslinkable and/or re-crosslinked PPGs may be used in a method of enhancing oil recovery from an oil source, comprising (i) providing a formulation comprising re-crosslinkable PPGs comprising soluble linear chains that permit re-crosslinking and/or bonding of the PPGs and at least one re-crosslinker or a composition containing as discussed herein, and (ii) delivering the re-crosslinkable PPG and at least one re-crosslinker containing formulation into the oil source, whereby the formulation enhances oil recovery from the oil source. Additionally, said PPGs may be used in a method of treating a petroleum-containing formation to reduce sand production, comprising: (i) providing a formulation comprising re-crosslinkable PPGs comprising soluble linear chains that permit re-crosslinking and/or bonding of the PPGs and at least one re-crosslinker or a composition containing as discussed herein, and (ii) delivering said PPGs and at least one re-crosslinker or composition containing into the petroleum-containing formation, whereby the formulation reduces sand production in the formation. Furthermore, said PPGs may be used in a method of displacing fluid from a wellbore by viscous plug flow, comprising: (i) providing re-crosslinkable PPGs comprising soluble linear chains that permit re-crosslinking and/or bonding of the PPGs and at least one re-crosslinker or a composition containing as discussed herein, and (ii) delivering the PPGs and at least one re-crosslinker into a wellbore, whereby the formulation forms a viscous plug in the wellbore, thereby displacing fluid therefrom.

In some embodiments, a method for re-crosslinking as described herein, may comprise (i) providing an aqueous composition comprising re-crosslinkable PPG as discussed herein, (ii) allowing the re-crosslinkable PPG to swell; and (iii) adding an amount of at least one re-crosslinker sufficient to provide for re-crosslinking of the PPGs, wherein the at least one re-crosslinker is added before, during and/or after swelling. In some embodiments, a method of enhanced oil recovery may comprise: (i) obtaining or providing a composition comprising PPGs as discussed herein and at least one re-crosslinker as described herein; (ii) placing the composition in a subterranean formation downhole; and (iii) extracting material comprising petroleum from the subterranean formation downhole via a production wellbore. In some embodiments, re-crosslinking of the PPGs may occur in a subterranean formation. In some embodiments, during said method, the composition comprising PPGs and at least one re-crosslinker is placed downhole via an injection wellbore. In some embodiments of said method, extraction may be effected using a production wellbore. In some embodiments of a method comprising use of the re-crosslinkable PPGs discussed herein, a composition comprising said PPGs and at least one re-crosslinker may be placed in the subterranean formation downhole comprises placing the composition in a producing zone downhole, and wherein the extracting of the material comprising petroleum from the subterranean formation downhole comprises extracting of the material from the producing zone.

Additionally, in some embodiments, a method for remediation of a zone within a subterranean formation bearing heavy/viscous oil to inhibit breakthrough of water from a water injection well via the zone into a production well, the zone comprised of a void space, a halo region, or both, within the zone due to production of the heavy/viscous oil through the production well, the zone thereby allowing for pressure communication between the injection well and the production well, may comprise: (i) injecting a composition into the zone via the injection well, the composition comprising re-crosslinkable PPGs comprising soluble linear chains and at least one re-crosslinker or a composition as described herein; (ii) allowing the re-crosslinkable PPGs to set for a time sufficient to thereby form a plug which reduces flow communication of water between the injection well and the production well. In some embodiments of said method, the displacement fluid is selected from water, alcohols, fuel oil or crude oil. In some embodiments of said method, the displacement fluid is water.

Due to the characteristics of the re-crosslinkable PPGs, such as its hydrophilic nature, initial size, and that it may be re-crosslinked, re-crosslinkable PPGs can propagate far into a reservoir. In some embodiments, re-crosslinkable PPGs and at least one re-crosslinker and/or a composition comprising re-crosslinkable PPGs may be added to injection water as part of a secondary or tertiary water recovery process, carbon dioxide injection, chemical, or air injection for recovery of hydrocarbon from subterranean sandstone or carbonate formation. This may allow for control of the near well-bore and in-depth formation conformance vertically and laterally by selectively blocking the high water channels.

Having generally described various aspects of the invention, the invention will be described more in detail with reference to the following examples, however the invention should not be limited to these examples. Indeed these examples are intended to describe examples of methods for producing re-crosslinkable PPGs and processes of using same according to the invention.

### EXAMPLES

PPG Preparation

PPG 1, PPG 2, and PPG 3 Polymerization

PPG 1, PPG 2, and PPG 3 were prepared according the following procedure. 56.8 parts acrylamide (AMD) solution (38%), 2.4 parts acrylic acid (AA) and 36.2 parts water were mixed together. Next, the pH value of the solution was adjusted to 7.0 with 4.1 parts 45% potassium hydroxide solution. Following pH adjustment, 0.07 parts of 70% 2, 2′ azo bis (2-methylpropionamidine) dihydrogen chloride and 0.004 parts 2 mercaptobenzothiazole were added to the solution. Then, the solution was divided into thirds and 0.004 (PPG 1), 0.008 (PPG 2), and 0.012 (PPG 3) parts 3.0% methylene bisacrylamide (5, 10 and 15 ppm on monomer, PPG 1, PPG 2, and PPG 3, respectively) respectively and were added to each solution. The three solutions were then cooled to approximately −2° C. Afterward, the three solutions were added to separate, sealed Dewar containers and purged with nitrogen for 1 hour. Following the one hour purge with nitrogen, 0.2 parts 0.2% t-butyl hydroperoxide and 0.2 parts 0.4% sodium sulfite were added to each container, and the monomers then polymerized to form a solid polymer gel.

PPG 4 Polymerization

PPG 4 was polymerized using a similar procedure as the one used for PPG 1, PPG 2, and PPG 3, except 0.12 parts 0.75% methylene bisacrylamide (37 ppm on monomer) was added to the solution.

PPG 5 and PPG 6 Polymerization

PPG 5 and PPG 6 were polymerized using a similar procedure as the one used for PPG 1, PPG 2, and PPG 3, except for the following differences: 44.2 parts acrylamide solution (38%), 7.2 parts acrylic acid, and 36.0 parts water were mixed together. The pH was adjusted to a value of 7.0 with 12.1 parts 45% potassium hydroxide solution. The solution was divided in half, and 0.004 (PPG 5) and 0.012 (PPG 6) parts 3.0% methylene bisacrylamide (5 and 15 ppm on monomer, PPG 5 and PPG 6, respectively) respectively were added to each solution.

PPG 7 Polymerization

PPG 7 was polymerized using a procedure similar to the one used for PPG 5 and PPG 6, except 0.07 parts 0.75% methylene bisacrylamide (22 ppm on monomer) was added to the solution.

PPG 11 Polymerization

PPG 11 was polymerized using a procedure similar to the one used for PPG 1, PPG 2, and PPG 3, except that no methylene bisacrylamide was added to the solution.

PPG 12 Polymerization

PPG 12 was polymerized by dissolving 1 part of PPG 11 in 58.6 parts acrylamide (AMD) solution (38%), 2.4 parts acrylic acid (AA) and 32.9 parts water were mixed together. Next, the pH value of the solution was adjusted to 7.0 with 4.0 parts 45% potassium hydroxide solution. 0.64 parts 0.75% methylene bisacrylamide (200 ppm on monomer) was added to the solution. The result was a dual polymer network of linear PPG and a PPG with 200 ppm MBA.

PPG 13 Polymerization

PPG 13 was polymerized using a similar procedure to the one used for PPG 1, PPG 2, and PPG 3, except for the following differences. 0.064 parts 0.75% methylene bisacrylamide (20 ppm on monomer) and 0.024 parts diethylenetriamine pentaacetic acid pentasodium salt (DTPA, 40%) were added to the solution. Next, the pH value of the solution was adjusted to 6.8 with 4.0 parts 45% potassium hydroxide solution.

PPG 14 Polymerization

PPG 14 was polymerized using a similar procedure as the one used for PPG 13, except for the following differences. 73.0 parts acrylamide solution (38%), 0.28 parts acrylic acid, and 25.3 parts water were mixed together. The pH was adjusted to a value of 6.8 with 0.7 parts 45% potassium hydroxide solution. 0.19 parts 0.75% methylene bisacrylamide (50 ppm on monomer) was added to the solution.

PPG 15 Polymerization

PPG 15 was polymerized using a similar procedure as the one used for PPG 14, except for the following differences. 33.2 parts acrylamide solution (38%), 15.4 parts acrylic acid, and 25.4 parts water were mixed together. The pH was adjusted to a value of 6.8 with 25.5 parts 45% potassium hydroxide solution. 0.045 parts 0.75% methylene bisacrylamide (12 ppm on monomer) was added to the solution.

PPG 16 Polymerization

PPG 16 was polymerized using a similar procedure as the one used for PPG 13, except for the following differences. 22.1 parts acrylamide solution (38%), 19.6 parts acrylic acid, and 25.4 parts water were mixed together. The pH was adjusted to a value of 6.8 with 32.3 parts 45% potassium hydroxide solution. 0.034 parts 0.75% methylene bisacrylamide (8 ppm on monomer) was added to the solution.

PPG 17 Polymerization

PPG 17 was polymerized using a similar procedure as the one used for PPG 1, 2 and 3 except for the following differences: 56.8 parts acrylamide solution (38%), 4.8 parts 2-acrylamido-2-methylpropane sulfonic acid (ATBS) and 37.9 parts water were mixed together. The pH was not adjusted. The solution was divided in half, 0.024 parts 0.75% methylene bisacrylamide (15 ppm on monomer) was added to the PPG 17 solution. The other half of the solution was used for Comparative PPG 10.

Comparative PPG 8 Polymerization

PPG 8 was polymerized using a procedure similar to the one used for PPG 1, PPG 2, and PPG 3, except that 0.002 parts methylene bisacrylamide (100 ppm on monomer) were added to the solution.

Comparative PPG 9 Polymerization

PPG 9 was polymerized using a procedure similar to the one used for PPG 5, PPG 6, and PPG 7, except that 0.0012 parts methylene bisacrylamide (75 ppm on monomer) were added to the solution.

Comparative PPG 10 Polymerization

Comparative PPG 10 was polymerized using a similar procedure as the one used for PPG 17, except 0.16 parts 0.75% methylene bisacrylamide (100 ppm on monomer) was added to the PPG solution.

PPG Processing

PPGs and comparative PPGs were processed as follows: For each PPG (except PPG 13 in Example 7, which was cut to a larger size), the polymer gel was cut into approximately 2 cm³ pieces with scissors. Cutting oil (2% Sorbitan monolaurate in paraffin oil) was then applied to completely coat the surfaces of each of the gel pieces for each of the PPG samples. Next, each PPG sample was individually added to a Weston commercial meat grinder and ground using said meat grinder. Each of the ground gels were then dried in a Sherwood fluid bed dryer. The dried gel particles were then pulverized in a Waring commercial blender for each of the PPG samples. The dried gel particles were then sieved to 1 to 3.35 mm particle size using U.S. standard sieves No. 6 and 18 to produce each of the different PPGs except for PPGs in Examples 7 and 16, which were sieved to different size ranges.

Re-crosslinking of PPG Preparations

PPGs and comparative PPGs were re-crosslinked using the following procedure: 5 parts of a PPG preparation were added to 95 parts brine and then were mixed by shaking for 90 seconds. Each of the mixtures was then allowed to swell for 3 hours to produce a swollen gel. After the 3 hour period, chromium propionate was added at 1:364 chromium propionate/PPG for each of the PPG mixtures and then were mixed by stirring. Each of the mixtures were then allowed to re-crosslink over a 6 day period, thereby forming a solid viscoelastic gel in most cases, as will be discussed further below.

PPG 13 in Example 4 was re-crosslinked as above except, 2 parts of PPG 13 was added to 98 parts DI water. PPGs in Example 13 and 14 were crosslinked as above except, 2.25 parts of PPG were added to 97.75 parts brine.

PPG 13 in Example 16 was re-crosslinked as above except, that different re-crosslinkers and time periods were used as described below. The mixtures were also stirred for 3 hours during the swelling and after the re-crosslinker addition.

PPG 17 in Example 17 was re-crosslinked as above except, that 2.25 parts of PPG were added to 97.75 parts brine and the mixtures were also stirred for 3 hours during the swelling and after the re-crosslinker addition. PPG 17 was then allowed to re-crosslink over a 15 day period.

### PPG Swell Capacity Tests

The PPG swell capacity tests, as discussed further below, were generally performed as follows. Master batches of the brine were prepared by adding appropriate salt at 1% solids to DI water and heating to 135° F. Next, 99.5 mL of the brine was poured into 100 mL graduated cylinder, and then 0.5 g of an individual pre-re-crosslinked PPG preparation were added. The top of the cylinder was then sealed off, and the cylinder containing the sample was inverted two to three times before placing in oven. Afterward, measurements of 1-3.35 mm particle size range pre-crosslinked PPG swell volumes were taken after 2 hours.

PPG 13 swell capacity test in Example 4 was measured as above except, it was prepared by adding 98 mL of DI water and then 2.0 g of PPG 13. PPG 13 swell capacity test in Example 7 was measured as above except, it was used at room temperature.

PPG 3 and 6 swell capacity were measured as above except the swell volumes were taken at different time intervals. PPG 13 and 13 in Examples 13 and 14 and PPG 13 in Example 16 were measured as above except, they were prepared by adding 97.5 mL of DI water and then 2.25 g of PPG. PPG 16 was also stirred for 3 hours before the swell volume was taken.

The initial PPG volume was determined from the density of the sample by weighing 40 mL of sample in a graduated container. The measured swell volume was divided by the initial PPG volume to obtain swell capacity.

PPG Elongation Test

The elongation of re-crosslinked PPG preparations was measured as follows. The diameter of the re-crosslinked PPG (initial) was first measured. Then, the re-crosslinked PPG gel was stretched on a ruler until it broke. The length when breakage occurred was noted and then divided by the initial diameter, which thereby gave the elongation value.

### Example 1: PPG Swell Capacity and Elongation Results in 1% KCl

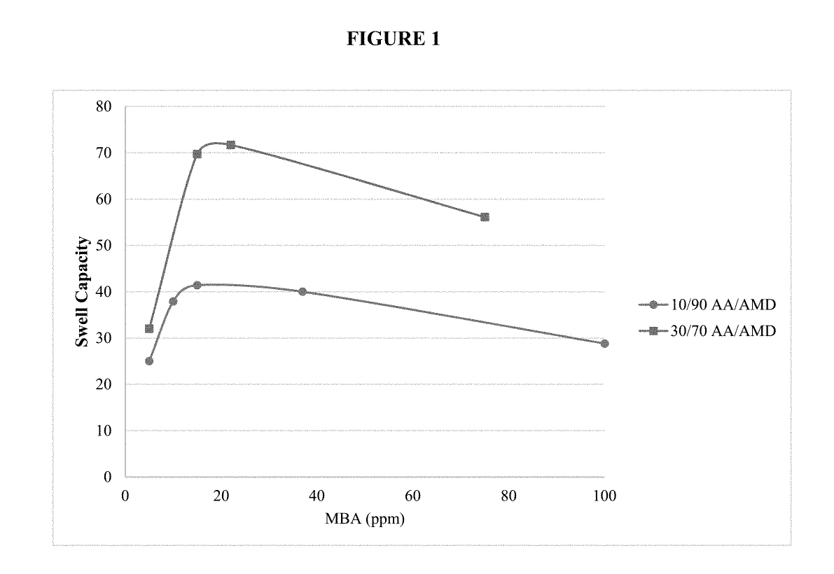

Swell capacity was measured after 2 hours at neutral pH and 135° F. (see Table 1). PPG preparations were swollen and re-crosslinked in 1% KCL brine at neutral pH and room temperature for elongation measurement (see Table 1). PPG preparations 1-7 could be stretched, showing elongation, and PPG preparations 1-7 also displayed swell capacity. PPG preparations 8 and 9 had higher amounts of MBA and could not be re-crosslinked, and therefore remained individual particles. For PPG preparations 1-4 and 8, there is a maximum swell capacity for preparation 3 (PPG 3) and the highest elongation for preparation 1 (PPG 1, which had the lowest MBA level at 5 ppm). For PPG preparations 5-7 and 9, there was a maximum swell capacity for preparation 7 (PPG 7) and the highest elongation for preparation 5 (PPG 5, which had the lowest MBA level at 5 ppm). As the MBA level is reduced, it can be seen that up to a point the swell capacity increases until a maximum amount of swell capacity is attained; essentially as a result of the presence of increasing amounts of soluble linear chains, which soluble linear chains are then re-crosslinked, as shown in the elongation results (see, for example, Table 1, Comparative PPG 8 vs. PPG 1-4; Comparative PPG 9 vs. PPG 3-7). FIG. 1 further presents the swell capacity results of Table 1 in graphical form.

TABLE 1

| PPG | | MBA | | Swell |
|---|---|---|---|---|
| Preparation | AA/AMD | (ppm) | Elongation | Capacity |
| 1 | 10/90 | 5 | 5.5 | 25 |
| 2 | 10/90 | 10 | 5 | 37.9 |
| 3 | 10/90 | 15 | 3.3 | 41.4 |
| 4 | 10/90 | 37 | 2.5 | 40 |
| 5 | 30/70 | 5 | 4.1 | 32 |
| 6 | 30/70 | 15 | 2.7 | 69.7 |
| 7 | 30/70 | 22 | 2.4 | 71.7 |
| Comparative 8 | 10/90 | 100 | n.a. | 28.8 |
| Comparative 9 | 30/70 | 75 | n.a. | 56.1 |

### Example 2: PPG Swell Capacity and Elongation Results in 1% KCl

PPG 14, 15 and 16 were polymerized and processed as described above. PPG preparations 14, 15 and 16 contained 1%, 55% and 70% AA respectively. Swell capacity was measured after 2 hours at neutral pH and 135° F. (see Table 2). PPG preparations were swollen and re-crosslinked in 1% KCL brine at neutral pH and room temperature for elongation measurement (see Table 2). PPG preparations 14, 15 and 16 could be stretched, showing elongation, and also displayed swell capacity. Preparations 14, 15 and 16 demonstrated that elongation and swell capacity can be achieved at a broad AA range.

TABLE 2

| PPG | | MBA | | Swell |
|---|---|---|---|---|
| Preparation | AA/AMD | (ppm) | Elongation | Capacity |
| 14 | 1/99 | 50 | 4.0 | 25 |
| 15 | 55/45 | 12 | 8.8 | 35 |
| 16 | 70/30 | 8 | 8.0 | 28 |

### Example 3: Swell Capacity and Elongation Results in Other Brines

PPG 1, PPG 3, PPG 5, PPG 7, comparative PPG 8 and comparative PPG 9 were polymerized and processed as described above, except each PPG preparation was sieved to 3.35 to 4 mm particle size using U.S. standard sieves No. 5 and 6 to produce the PPGs that were used for the experiments that produced the data as presented in Table 3.

Swell capacity was measured after 2 hours of a PPG sample being mixed into a solution containing either 1% NaCl, 1% CaCl₂, 1% KCl or seawater (Instant Ocean®) brine at neutral pH and 135° F. PPG was also swollen and re-crosslinked in 1% NaCl, 1% CaCl₂, 1% KCl or seawater (Instant Ocean®) brine at neutral pH and room temperature. PPG preparations 1, 3, 5 and 7 were able to be stretched, thereby showing elongation, and said PPG preparations also demonstrated swell capacity, both properties being demonstrated in various types of brines (see Table 3). PPG comparative preparations 8 and 9 were not able to be re-crosslinked and said PPG preparations remained individual particles in each brine.

TABLE 3

| | PPG | | PPG | | PPG | | PPG | |
|---|---|---|---|---|---|---|---|---|
| | Preparation 1 | | Preparation 3 | | Preparation 5 | | Preparation 7 | |
| | | Elon- | | Elon- | | Elon- | | Elon- |
| Brine | Swell | gate | Swell | gate | Swell | gate | Swell | gate |
| 1% KCl | 16 | 6.1 | 22 | 4.3 | 30 | 4.2 | 46 | 2.4 |
| 1% NaCl | 11 | 9.0 | 26 | 3.8 | 20 | 4.9 | 37 | 2.5 |
| Sea water | 12 | 6.4 | 16 | 4.2 | 16 | 5.4 | 18 | 2.6 |
| 1% CaCl2 | 15 | 5.7 | 18 | 5.4 | 23 | 4.8 | 22 | 2.7 |

### Example 4: PPG Swell Capacity and Elongation Results in DI Water

PPG 13 was polymerized and processed as described above. Swell capacity and elongation in DI water was measured at 2% solids at room temperature (Table 4). PPG preparation 13 could be stretched, showing elongation, and also displayed swell capacity. Example 4 demonstrated that very high swell capacity can be achieved.

TABLE 4

| PPG | | Swell |
|---|---|---|
| Preparation | Elongation | Capacity |
| 13 | 4.5 | 172 |

### Example 5: Swell Capacity and Elongation Results at Different Salinity

PPG 1, PPG 3, PPG 5, PPG 6, comparative PPG 8 and comparative PPG 9 were polymerized and processed as described above, except each PPG preparation was sieved to 1 to 3.35 mm particle size using U.S. standard sieves No. 6 and 18 to produce the PPGs that were used for the experiments that produced the data as presented in Table 5. Swell capacity was measured after 2 hours in different salinity at neutral pH and 135° F. Each PPG preparation was swollen and re-crosslinked in different salinity at neutral pH and room temperature. Swell capacity and elongation were achieved in different salinities (see Table 5). PPG comparative preparations 8 and 9 could not be re-crosslinked and remained individual particles in 2% and 3% KCl.

TABLE 5

| | PPG | | PPG | | PPG | | PPG | |
|---|---|---|---|---|---|---|---|---|
| | Preparation 1 | | Preparation 3 | | Preparation 5 | | Preparation 6 | |
| | | Elon- | | Elon- | | Elon- | | Elon- |
| Solids | Swell | gate | Swell | gate | Swell | gate | Swell | gate |
| 1% KCl | 25 | 6.0 | 41.4 | 3.8 | 44.6 | 4.5 | 69.7 | 2.7 |
| 2% KCl | 17.5 | 6.2 | 37.8 | 4.0 | 33.4 | 5.0 | 57.2 | 3.7 |
| 3% KCl | 17.5 | 7.4 | 37.8 | 6.1 | 32 | 6.0 | 50.2 | 3.7 |

### Example 6: Swell Capacity and Elongation Results at Different Particle Sizes

PPG 1, PPG 3, PPG 5, and PPG 6 were polymerized and processed as described above, except each PPG preparation was sieved to 425 m to 1 mm, 1 to 3.35 mm, or 3.35 to 4 mm particle size ranges using U.S. standard sieves No. 5, 6, 18 and 40 to produce the PPGs that were used to produce in experiments to produce that data as presented in Table 6. Swell capacity was measured after 2 hours at different particle size ranges at neutral pH and 135° F. (see Table 6). PPG was swollen and re-crosslinked in different particle size ranges at neutral pH and room temperature. Results demonstrated that swell capacity and elongation were able to be achieved at different particle sizes (see Table 6). Based on the data presented in Table 6, swell capacity decreased with larger particle size and elongation increased with larger particle size.

TABLE 6

| | PPG | | PPG | | PPG | | PPG | |
|---|---|---|---|---|---|---|---|---|
| | Preparation 1 | | Preparation 3 | | Preparation 5 | | Preparation 6 | |
| Particle | | Elon- | | Elon- | | Elon- | | Elon- |
| Size | Swell | gate | Swell | gate | Swell | gate | Swell | gate |
| 425 μm- | 25 | 6.0 | 41.4 | 3.8 | 44.6 | 4.5 | 69.7 | 2.7 |
| 1 mm | | | | | | | | |
| 1 mm- | 17.5 | 6.2 | 37.8 | 4.0 | 33.4 | 5.0 | 57.2 | 3.7 |
| 3.35 mm | | | | | | | | |
| 3.35 mm- | 17.5 | 7.4 | 37.8 | 6.1 | 32 | 6.0 | 50.2 | 3.7 |
| 4 mm | | | | | | | | |

### Example 7: Swell Capacity and Elongation Results at Larger Particle Size

PPG 13 was polymerized and processed as described above. PPG 13 particles were not pulverized or sieved to produce larger particles. Instead, the length, width and height of PPG 13 particles were measured by hand. The average length of each side was 9.8 mm with a range of 9-11 mm. PPG 13 was swollen and re-crosslinked in 1% KCl at neutral pH and room temperature. Results demonstrated that elongation was achieved at a much larger particle size (see Table 7).

TABLE 7

| PPG Preparation | Particle Size | Elongation |
|---|---|---|
| 13 | 9.8 mm | 6.5 |

### Example 8: Swell Capacity Over Time

PPG 3 and PPG 6 were prepared as described above and were subsequently used in experiments that produced the data as presented in Table 8. Swell capacity was measured over 24 hour period at various time intervals (see Table 8). It was noted that PPG preparations 3 and 6 achieved high swell capacity rapidly and increased over 24 hours.

TABLE 8

| | Preparation 3 | | | | | Preparation 6 | | | | |
|---|---|---|---|---|---|---|---|---|---|---|
| | 30 | 1 | 90 | 2 | 24 | 30 | 1 | 90 | 2 | 24 |
| Brine | min. | hour | min. | hours | hours | min. | hour | min. | hours | hours |
| 1% KCl | 23.2 | 30.5 | 37.8 | 41.4 | 84.1 | 34.9 | 48.8 | 59.9 | 69.7 | 125.5 |
| 1% NaCl | 19.5 | 29.3 | 35.4 | 40.2 | 91.4 | 34.9 | 48.8 | 58.5 | 66.9 | 139.4 |
| Sea water | 17.1 | 19.5 | 21.9 | 23.2 | 35.4 | 19.5 | 25.1 | 30.7 | 34.9 | 73.9 |
| 1% CaCl2 | 14.6 | 20.7 | 25.6 | 29.3 | 69.5 | 18.1 | 22.3 | 23.7 | 23.7 | 44.6 |

### Example 9: Re-Crosslinking of PPG that Contained 0 MBA

PPG 11 was prepared as described above, only the dried gel particles were sieved to 1 to 3.35 mm particle size using U.S. standard sieves No. 6 and 18 to produce the PPGs that were used for the experiments that produced that data as presented in Table 9. Swell capacity was measured after 2 hours in different salinity, neutral pH, and 135° F. (see Table 9). PPG was swollen and re-crosslinked in different salinity at neutral pH and room temperature. Though linear polyacrylamide is soluble in aqueous solutions, the salinity was sufficiently high and the time was sufficiently short to allow the linear PPG to not dissolve, and to demonstrate particles that were re-crosslinked.

TABLE 9

| PPG | | | Swell |
|---|---|---|---|
| Preparation | KCl | Elongation | Capacity |
| 11 | 2% | 5.5 | 13 |
| 11 | 3% | 7.6 | 12 |

### Example 10: Re-Crosslinking of PPG from Blended PPG Preparations

PPG blends were prepared as follows. Comparative PPG 8 and PPG 9, and PPG 11 were polymerized and prepared according to the above examples. PPG 11, which contains 0 ppm MBA, was subsequently dry blended with PPG preparations 8 and 9 in different ratios (see Table 10). Blends of PPGs demonstrated swell capacity and elongation (see Table 10). PPGs with higher levels of MBA that would not re-crosslink by themselves (Example 1) were able to be re-crosslinked by the blending of a linear PPG that would bind those particles. Note that “parts” in Table 10 represent parts of PPG in a total of 100 parts.

TABLE 10

| PPG 11 | PPG 8 | PPG 9 | | Swell |
|---|---|---|---|---|
| (parts) | (parts) | (parts) | Elongation | Capacity |
| 4 | | 1 | 2.4 | 43 |
| 3.5 | 1.5 | | 3.0 | 43.9 |
| 3.5 | | 1.5 | 4.8 | 36.8 |

### Comparative Example 11: Re-Crosslinking of PPG from Blended PPG Preparations

PPG 11, which contained 0 ppm MBA, and comparative PPG 8 were prepared as described above, and subsequently 4 parts of PPG 11 were dry blended with 1 part of PPG 8. The procedure for re-crosslinking of the PPG blend was then performed, however, it was found that the blended PPG preparation could not be re-crosslinked. It was found that the blended PPG preparation remained as individual particles. The amount of linear PPG was too low and/or the amount of MBA was too high to make a re-crosslinked PPG from the blend, and therefore remained individual particles. Note that “parts” represent parts of PPG in a total of 100 parts.

### Example 12: Double Polymer Network PPG Preparation

PPG 12, which contained 10 parts linear polymer and 90 parts PPG with 100 ppm MBA, based on 100 parts total of PPG was prepared as described above, and the procedure for re-crosslinking of the PPG blend was then performed. The double polymer network PPG demonstrated swell capacity and elongation (see Table 11) at an equivalent of 90 ppm MBA if it contained only 1 polymer.

TABLE 11

| PPG | | Swell |
|---|---|---|
| Preparation | Elongation | Capacity |
| 12 | 2.7 | 40.6 |

### Example 13: PPG and Re-Crosslinker Preparation

2.5 parts of solution of chromium propionate (11%) was added drop wise to coat 97.5 parts PPG 3. Wet powder was dried in an oven at 50° C. PPG was added at 2.25% solids to 1% KCL and stirred for 6 hours. PPG Swell capacity and elongation were measured at 2.25% PPG solids at RT.

### Example 14: PPG and Re-Crosslinker Preparation

20 parts of solution of chromium propionate (1.1%) was dried in an oven at 50° C. 80 parts PPG 3 was added and dry milled together. PPG was added at 2.25% solids to 1% KCL and stirred for 6 hours. PPG Swell capacity and elongation were measured at 2.25% PPG solids at RT.

Examples 13 and 14 showed swell capacity and elongation (see Table 12). Examples 13 and 14 showed that re-crosslinker PPG could be produced by adding re-crosslinker before swelling the PPG. The PPG's could be shipped as 1 package to the field location for easier addition.

TABLE 12

| PPG | | Swell |
|---|---|---|
| Example | Elongation | Capacity |
| 13 | 6.6 | 30.5 |
| 14 | 6.4 | 32.9 |

### Example 15: Treatment of Sand Pack with PPGs

PPG preparation 3 and comparative PPG 8 were polymerized and processed as described above, except each PPG preparation was sieved to 425 m to 1 mm. PPG 3 and 8 were added at 2.25% solids to 1% KCl brine to make swollen PPG dispersions. Re-crosslinker was added to PPG 3 and stirred for 3 hours. Four ml of both PPG dispersions were then pumped over 6 hours into a 2 darcy sand pack. Sand packs were sealed and stored for 7 days at room temperature. Then 1% KCL brine was pumped into the sand packs over 6 hours. Pressure was measured and any brine discharge was noted. The maximum pressure that could be recorded by the pressure gauge was ˜67 psi.

PPG preparation 3 in the sand pack sample showed maximum psi during the test and only 1 drop of brine emitted from the sand pack during the time period (see Table 13). On the other hand, comparative PPG 8 emitted several mL of brine during the test, had a slower increase in pressure and did not achieve the maximum pressure during the test. PPG preparation 3, which was re-crosslinked was superior in blocking the permeable sand pack.

TABLE 13

| PPG | One hour | Two hours | Three hours | Four hours |
|---|---|---|---|---|
| Preparation | (psi) | (psi) | (psi) | (psi) |
| 3 | 35.7 | 66.6 | 66.7 | 66.9 |
| | no discharge | no discharge | no discharge | 1 drop |
| Comparative 8 | 3.2 | 5.7 | 22.7 | 57.3 |
| | no discharge | few drops | Few ml | Several mL |

### Example 16: Re-crosslinking of PPG with Other Crosslinkers

PPG 13 was polymerized and processed as described above. Swell capacity was measured at 2.25% solids after stirring for 2 hours at neutral pH and room temperature (see Table 14). PPG preparation 13 was re-crosslinked by adding 5 parts of PPG preparation 13 to 95 parts brine and then stirring for 3 hours. Each of the mixtures was then allowed to swell for 3 hours to produce a swollen gel. After 3 hours, zirconium acetate, aluminum chloride or ferric chloride was added at 1:459, 1:193 and 1:218 re-crosslinker/PPG ratio respectively for each of the PPG mixtures and then were mixed by stirring for an additional 3 hours. Each of the mixtures were then allowed to re-crosslink over a 7 day period, thereby forming a solid viscoelastic gel (Table 14)

In addition, PPG Preparation 13 was polymerized and sieved to <1 mm particle size. PPG preparation 13 was then re-crosslinked by adding 5 parts of PPG preparation 13 to 95 parts brine and then stirring for 3 hours. The pH was adjusted to 11.0 with sodium hydroxide. The mixture was then allowed to swell for 3 hours to produce a swollen gel. After 3 hours, sodium tetraborate was added at 1:10 re-crosslinker/PPG ratio and then was mixed by stirring for an additional 3 hours. The mixture was then allowed to re-crosslink over a 30 day period, thereby forming a solid gel (Table 14).

Example 16 showed that these PPGs were re-crosslinked and showed elongation using other re-crosslinkers.

TABLE 14

| PPG Preparation | Re-crosslinker | Elongation |
|---|---|---|
| 13 | Zirconium acetate | 3.3 |
| 13 | Aluminum chloride | 3.5 |
| 13 | Ferric chloride | 2.4 |
| 13 | Sodium tetraborate | 4.5 |

### Example 17: PPG Swell Capacity and Elongation Results with a TBS/AMD Copolymer

PPG Preparation 17 and comparative PPG 10 were polymerized and processed as described above. Swell capacity was measured after 2 hours at neutral pH and 135° F. (see Table 14). For the elongation test, 2.25 parts of PPG preparation 17 and comparative PPG 10 were added to 97.75 parts brine and then stirred for 3 hours. Each of the mixtures was then allowed to swell for 3 hours under stirring to produce a swollen gel before adding the re-crosslinker. Each of the mixtures was then allowed to re-crosslink over a 15 day period (Table 15).

PPG preparation 17 could be stretched, showing elongation, and also displayed swell capacity. Comparative PPG preparation 10 had higher amount of MBA and could not be re-crosslinked, and therefore remained individual particles. PPG preparation 17 demonstrated that ATBS/AMD copolymer could be re-crosslinked.

TABLE 15

| | | MBA | | Swell |
|---|---|---|---|---|
| PPG Preparation | ATBS/AMD | (ppm) | Elongation | Capacity |
| 17 | 10/90 | 15 | 6.5 | 18.8 |
| Comparative 10 | 10/90 | 100 | n.a. | 16.2 |

### Example 18: PPG Swell Capacity Results with Varying Crosslinker Levels

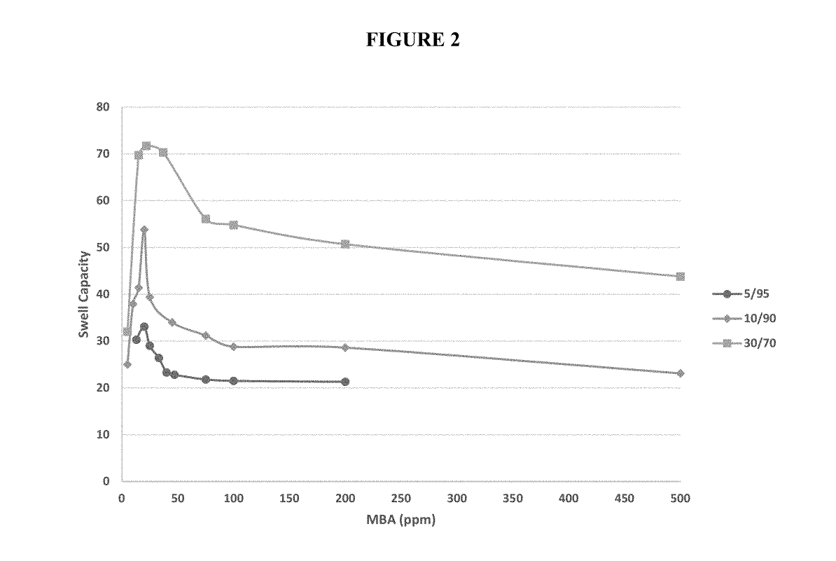

PPG 1-7, comparative PPG 8, comparative PPG 9, and additional PPGs (PPG preparations 18-26; see Table 16) were polymerized and processed as described above to produce the PPGs that were used for the experiments that produced the data as presented in FIG. 2. PPG preparations 18 to 26 were polymerized using a similar procedure to the one used for PPG preparation 13, except for the following differences: the ratio of acrylamide to acrylic acid was 95/5 and the MBA content was adjusted as shown in Table 16. PPG preparations 27 to 32 were polymerized using a similar procedure as the one used for PPG 1, PPG 2, and PPG 3, except the MBA content was adjusted as shown in Table 16. PPG preparations 33 to 36 were polymerized using a similar procedure as the one used for PPG 5, PPG 6, and PPG 7, except the MBA content was adjusted as shown in Table 16.

Swell capacity was measured after 2 hours of a PPG sample being mixed into a solution containing 1% KCl brine at neutral pH and 135° F. (see FIG. 2).

Referring now to FIG. 2, the data of FIG. 2 demonstrated that, up to a point, there was an increase in swell capacity as the MBA levels of the PPG preparations were decreased. For example, PPG preparations comprising 30% acrylamide and 70% acrylic acid (see FIG. 2: 30/70) had a maximum swell capacity at 22 ppm MBA under the conditions of the present example. PPG preparations comprising 10% acrylamide and 90% acrylic acid (see FIG. 2: 10/90) had a maximum swell capacity at 20 ppm MBA under the conditions of the present example. PPG preparations comprising 5% acrylamide and 95% acrylic acid (see FIG. 2: 5/95) had a maximum swell capacity at 20 ppm MBA under the conditions of the present example.

TABLE 16

| PPG | | |
|---|---|---|
| Preparation | AA/AMD | MBA (ppm) |
| 18 | 5/95 | 13 |
| 19 | 5/95 | 20 |
| 20 | 5/95 | 25 |
| 21 | 5/95 | 33 |
| 22 | 5/95 | 40 |
| 23 | 5/95 | 47 |
| 24 | 5/95 | 75 |
| 25 | 5/95 | 100 |
| 26 | 5/95 | 200 |
| 27 | 10/90 | 20 |
| 28 | 10/90 | 25 |
| 29 | 10/90 | 45 |
| 30 | 10/90 | 75 |
| 31 | 10/90 | 200 |
| 32 | 10/90 | 500 |
| 33 | 30/70 | 37 |
| 34 | 30/70 | 100 |
| 35 | 30/70 | 200 |
| 36 | 30/70 | 500 |

### Example 19: PPG Swell Capacity Results with Varying Crosslinker Levels in Different Brines

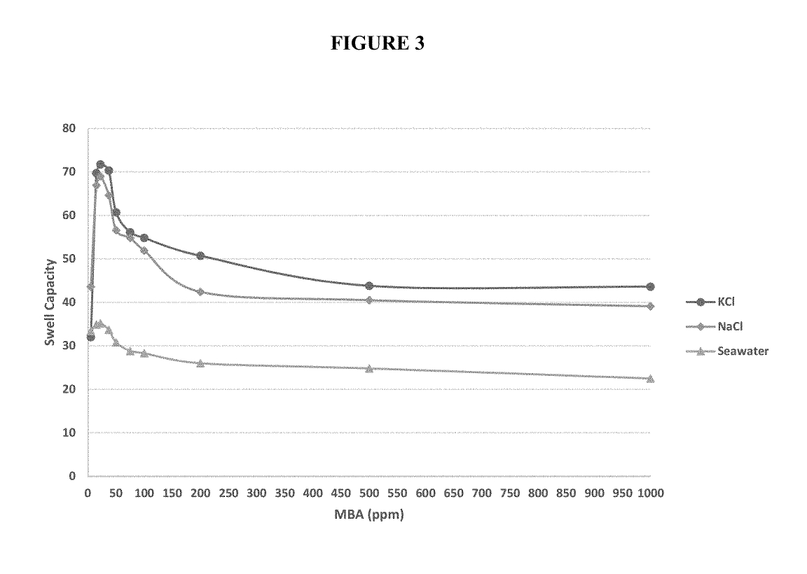

PPG preparations 5, 6, 7, 33, 34, 35, 36, Comparative PPG 8, and additional PPGs (PPG preparations 37 and 38; see Table 17) were polymerized and processed as described above to produce the PPGs that were used for the experiments that produced the data as presented in FIG. 3. PPG preparations 37 and 38 were polymerized using a similar procedure to the one used for PPG 5, PPG 6, and PPG 7 except the MBA content was adjusted as shown in Table 17.

Swell capacity was measured after 2 hours of a PPG sample being mixed into a solution containing either 1% NaCl (see FIG. 3: NaCl), 1% KCl (see FIG. 3: KCl), or seawater (Instant Ocean®) brine (see FIG. 3: Seawater) at neutral pH and 135°.

Referring now to FIG. 3, the data of FIG. 3 demonstrated that up to a point, there was an increase in swell capacity as the MBA levels of the PPG preparations were decreased. For example, in either 1% KCl, 1% NaCl, or seawater, there was a maximum in swell capacity at 22 ppm MBA (see FIG. 3).

TABLE 17

| PPG | | |
|---|---|---|
| Preparation | AA/AMD | MBA (ppm) |
| 37 | 30/70 | 50 |
| 38 | 30/70 | 1000 |

In the preceding procedures, various steps have been described. It will, however, be evident that various modifications and changes may be made thereto, and additional procedures may be implemented, without departing from the broader scope of the procedures as set forth in the claims that follow.

1. A composition comprising one or more re-crosslinkable, swellable preformed particle gel (“PPGs”) wherein said one or more re-crosslinkable PPGs when re-crosslinked with at least one re-crosslinker are suitable for use as a conformance control agent, and further wherein said one or more re-crosslinkable PPGs are dispersible in water or other aqueous composition and said one or more PPGs comprise a sufficient amount or number of soluble linear chains to facilitate re-crosslinking.

2. The composition of claim 1, wherein:
(i) said re-crosslinkable PPGs are produced by a polymerization process which includes the addition of a covalent crosslinking agent;
(ii) said re-crosslinkable PPGs are produced by a polymerization process which does not include the addition of an ionic crosslinking agent;
(iii) said composition further comprises at least one re-crosslinker;
(iv) said composition further comprises brine, produced water, flowback water, brackish water, and/and sea water;
(v) said soluble linear chains result in whole or part by a decreased level of crosslinking during formation of the re-crosslinkable PPG;
(vi) said re-crosslinkable PPGs comprise a decreased level of crosslinking resulting in decreased swell capacity and increased strength (elongation) upon the addition of a re-crosslinking agent;
(vii) said re-crosslinkable PPGs comprise a decreased level of crosslinking resulting in increased swell capacity and increased strength (elongation) upon the addition of a re-crosslinking agent;
(viii) said re-crosslinkable PPGs comprise soluble linear chains which are provided in whole or part by polymers comprising soluble linear chains;
(ix) said re-crosslinkable PPGs comprise soluble linear chains which provide for improved viscoelastic strength upon the addition of a re-crosslinking agent and/or re-crosslinking, further wherein optionally said re-crosslinking agent comprises at least one ionic crosslinker;
(x) said re-crosslinkable PPGs comprise weaker or more brittle re-crosslinking bonds upon the addition of a re-crosslinking agent and/or upon re-crosslinking;
(xi) said re-crosslinkable PPGs when re-crosslinked are better able to withstand pressure and remain in pores or voids in comparison to conventional PPGs, e.g., those which may be displaced under similar conditions, e.g., similar pressure conditions, and/or upon the addition of re-crosslinker and/or re-crosslinking;
(xii) said re-crosslinkable PPGs comprise linear chains which comprise at least one carboxylic acid group, e.g., an acrylate group;
(xiii) said re-crosslinkable PPGs before and/or after re-crosslinking possess properties such as size, mechanical strength, swell capacity that permit their use in processes wherein conventional PPGs are used, for example, in enhanced oil recovery processes;
(xiv) said re-crosslinkable PPGs bond to one another upon re-crosslinking;
(xv) said re-crosslinkable PPGs are re-crosslinked to bond at least some of the soluble linear chains;
(xvi) said re-crosslinkable PPGs are swollen above the surface, e.g., before use as a conformance control agent in a chosen environment;
(xvii) said re-crosslinkable PPGs re-crosslink under aqueous conditions when contacted with at least one re-crosslinker;
(xviii) at least one crosslinker in the monomer composition used to produce said re-crosslinkable PPGs comprises a stable or covalent crosslinker, e.g., inorganic or organic, or combination thereof, e.g., which does not disintegrate when added during the polymerization process resulting in formation of the re-crosslinkable PPG which is swellable in water or brine;
(xix) at least one crosslinker in the monomer composition used to produce said re-crosslinkable PPGs comprises methylenebisacrylamide, hexamethylenetetramine, diallylamine, triallylamine, divinyl sulfone, diethyleneglycol diallyl ether, divinyl benzene, allylmethacrylate and/or phenol aldehyde during the polymerization process resulting in formation of the re-crosslinkable PPG;
(xx) said at least one crosslinker in the monomer composition of a re-crosslinkable PPG used to produce the re-crosslinkable PPG comprises MBA which is added during the polymerization process resulting in formation of the re-crosslinkable PPG;
(xxi) said composition comprises an aqueous fluid, e.g., fresh water or brine;
(xxii) said re-crosslinkable PPGs when re-crosslinked are suitable for use as a conformance control agent, e.g., for use in enhanced oil recovery;
(xxiii) said re-crosslinkable PPGs when re-crosslinked are suitable for use chemical flooding, e.g., polymer flooding, alkaline polymer flooding, alkali-polymer-surfactant enhanced oil recovery, micellar polymer flooding, and surfactant polymer flooding;
(xxiv) said re-crosslinkable PPGs when re-crosslinked are suitable for use in one or more of (1) water and gas shutoff, (2) fluid loss control, (3) zone abandonment, (4) water and gas coning, squeeze and recompletion, (5) chemical liner completions and lost circulation during drilling operations and (6) plugging during drilling and drilling completion;
(xxv) said composition when used as a conformance control agent when re-crosslinked provides for enhanced hydrocarbon recovery and/or improved sweep efficiency;
(xxvi) said re-crosslinkable PPGs comprise polymers which comprise nonionic, anionic, and/or cationic monomers;
(xxvii) said re-crosslinkable PPGs comprises a nonionic polymer that is later hydrolyzed to comprise carboxylate groups further wherein optionally hydrolyzation is produced by heat, adding metal or ammonium hydroxides, and/or sodium carbonate;
(xxviii) said re-crosslinkable PPGs are re-crosslinked after said re-crosslinkable PPGs or a composition containing have been introduced or injected into a desired structure, e.g., a structure comprising pores, voids, and/or channels;
(xxix) said re-crosslinkable PPGs are re-crosslinked at temperatures ranging from 4° C. to 150° C.;
(xxx) said re-crosslinkable PPGs are re-crosslinked at room temperature;
(xxxi) said re-crosslinkable PPGs are unswollen, partially swollen, or substantially swollen topside prior to introduction and/or injection into one or more desired locations;
(xxxii) the monomer composition used to produce said re-crosslinkable PPGs comprises one or more re-crosslinkable components other than the linear polymer chains that are re-crosslinked with a re-crosslinking agent, wherein optionally said re-crosslinkable components in the monomer composition include, for example: one or more initiators, such as, but not limited to ammonium persulfate, potassium persulfate, sodium persulfate, sodium bromate, sodium sulfite, potassium sulfite or mixture, and 2,2′-azobis(2-methylpropiopionitrile) peroxides such as, but not limited to t-butyl peroxide, benzoyl peroxide, diidopropylbenzene peroxide, azobisisobutyronitrile, optionally with bases, such as, but not limited to sodium carbonate, sodium bicarbonate, sodium hydroxide, reducing promoters, such as, but not limited to potassium metabisulfite, sodium sulfite, thionyl chloride, thionyl bromide; regulators such as, but not limited to alcohols; stabilizers, such as, but not limited to phenol, m-dihydroxybenzene, hydroquinone; chelating agents such as, but not limited to ethylene diamine tetra acetate (EDTA) and diethylenetriamine pentaacetate (DTPA); thermal agents such as, but not limited to 2-acrylamido-2-methyl propane sulfonic acid; chain-transfer agents, such as, but not limited to thiols such as dodecyl mercaptan, formic acid and alkali metal formates such as sodium formate; oxygen scavengers such as, but not limited to sodium sulfite, sodium bisulfite, sodium thiosulfate, sodium lignosulfate, ammonium bisulfite, hydroquinone, diethylhydroxyethanol, diethylhydroxylamine, methylethylketoxime, ascorbic acid, erythorbic acid, and sodium erythorbate; pH adjusters such as, but not limited to sodium, ammonium or potassium hydroxide; and/or gel strength, thermal and chemical resistance modifiers, such as, but not limited to bentonite, lignocellulose, clay, laponite, montnorillonite, diatomite, kaolinoite, titania, silica, silicates and other fillers, or combinations or mixtures thereof;
(xxiii) said composition further comprises one or more of a surfactant, an aqueous liquid, a fluid comprising at least one of water, an organic solvent, and an oil, a buffer, a mobility buffer, a drive fluid, or another viscosifier;
(xxxiv) the re-crosslinker is added in whole or part as a solid to dry re-crosslinkable PPGs and mixed or blended;
(xxxv) the re-crosslinker is added in whole or part as a liquid and dried on said re-crosslinkable PPGs;
(xxxvi) said re-crosslinkable PPGs are further ground;
(xxxvii) said composition is comprised in a single package;
(xxxviii) said composition further comprises a re-crosslinker and further wherein said re-crosslinker comprises a multivalent metal crosslinking agent such as Al⁺³, Fe+3, Cr³⁺, Ti⁺4, Sn⁺⁴, Zr⁺⁴ or a combination or salt thereof such as acetates, nitrates, phosphates, carbonates, propionates, benzoates, formates, citrates and the like;
(xxxix) said composition further comprises a re-crosslinker, further wherein said re-crosslinker comprises inorganic agents such as aluminum salt, e.g., aluminum chloride; chromium salt, e.g., chromium acetate; zirconium salt, e.g., zirconium acetate; iron salt, e.g., ferric chloride; titanium salt; chromium salt; organic agents such as phenol, polyethyleneimine (“PEI”) and formaldehyde; one or more polysaccharides; and/or a combination or blend of one or more crosslinkers and/or re-crosslinkers;
(xl) said composition further comprises a re-crosslinker, further wherein said re-crosslinker comprises a borate source such as boronic acid, boronate ester, sodium tetraborate or sodium tetraborate decahydrate crosslinking agent and the like;
(xli) said composition further comprises a re-crosslinker, further wherein said re-crosslinker comprises at least one multivalent Group III-Group VII transition metal molecule, and/or a combination or salt thereof;
(xlii) said composition further comprises a re-crosslinker, further wherein said re-crosslinker comprises a combination of different re-crosslinkers;
(xliii) said PPGs are re-crosslinked by the addition of at least one water soluble re-crosslinker resulting in re-crosslinked PPGs, optionally wherein the water soluble re-crosslinker comprises a transitional metal, organic, and/or borate;
(xliv) said re-crosslinkable PPGs are re-crosslinkable or re-crosslinked using a water soluble re-crosslinker which comprises one or more transitional multivalent ions;
(xlv) said re-crosslinkable PPGs comprise between 1-99% of carboxylate groups;
(xlvi) said re-crosslinkable PPGs are re-crosslinkable or re-crosslinked using a water soluble re-crosslinker which comprises chromium propionate;
(xlvii) said re-crosslinkable PPGs comprise a decreased level of crosslinking in the re-crosslinkable PPGs is obtained by blending a conventional crosslinking PPG with a linear polymer;
(xlviii) said re-crosslinkable PPGs comprise a decreased level of crosslinking are obtained by dissolving DPAM in a conventional crosslinking level PPG monomer solution and incubating these constituents under reaction conditions effective to form a double polymer network;
(xlix) at least one re-crosslinking agent is added to said re-crosslinkable PPGs comprising soluble linear chains;
(l) a re-crosslinking agent comprising one or more polysaccharides is added to said composition;
(li) said re-crosslinkable PPGs comprise 0 ppm of a crosslinker comprised in the polymer;
(lii) the monomer composition used to produce said re-crosslinkable PPGs comprises at least one stable or covalent crosslinker, optionally wherein said crosslinker comprises methylene bisacrylamide (“MBA”);
(liii) the monomer composition used to produce said re-crosslinkable PPGs comprises at least one stable or covalent crosslinker, wherein said crosslinker comprises methylene bisacrylamide (“MBA”), and further where said MBA comprises 0.1 ppm or less, 0.5 ppm or less, 1.0 ppm or less, 2.0 ppm or less, 3.0 ppm or less, 4.0 ppm or less, 5.0 ppm or less, 6.0 ppm or less, 7.0 ppm or less, 8.0 ppm or less, 9.0 ppm or less, 10.0 ppm or less, 12.5 ppm or less, 15.0 ppm or less, 17.5 ppm or less, 20.0 ppm or less, 22.5 ppm or less, 25.0 ppm or less, 27.5 ppm or less, 30.0 ppm or less, 32.5 ppm or less, 35.0 ppm or less, 37.5 ppm or less, 40.0 ppm or less, 42.5 ppm or less, 45.0 ppm or less, 47.5 ppm or less, 50.0 ppm or less, 52.5 ppm or less, 55.0 ppm or less, 57.5 ppm or less, 60.0 ppm or less, 62.5 ppm or less, 65.0 ppm or less, 67.5 ppm or less, 70.0 ppm or less, 72.5 ppm or less, 75.0 ppm or less, 77.5 ppm or less, 80.0 ppm or less, 82.5 ppm or less, 85.0 ppm or less, 87.5 ppm or less, 90.0 ppm or less, 92.5 ppm or less, 95.0 ppm or less, 97.5 ppm or less, or 100.0 ppm or less in the polymer;
(liv) said PPGs comprise a diameter that is suitable to obtain a desired result, e.g., use in conformance control;
(lv) said PPGs comprise particles comprising a diameter that is suitable for use in EOR processes;
(lvi) said PPGs comprise particles comprising a diameter of 0.10 μm or less, 0.5 μm or less, 1.0 μm or less, 10.0 μm or less, 50.0 μm or less, 0.1 mm or less, 0.15 mm or less, 0.20 mm or less, 0.25 mm or less, 0.30 mm or less, 0.35 mm or less, 0.40 mm or less, 0.45 mm or less, 0.50 mm or less, 0.55 mm or less, 0.60 mm or less, 0.65 mm or less, 0.70 mm or less, 0.75 mm or less, 0.80 mm or less, 0.90 mm or less, 0.95 mm or less, 1.00 mm or less, 1.10 mm or less, 1.20 mm or less, 1.30 mm or less, 1.40 mm or less, 1.50 mm or less, 1.60 mm or less, 1.70 mm or less, 1.80 mm or less, 1.90 mm or less, 2.00 mm or less, 2.25 mm or less, 2.50 mm or less, 2.75 mm or less, 3.00 mm or less, 3.25 mm or less, 3.50 mm or less, 3.75 mm or less, 4.00 mm or less, 4.25 mm or less, 4.50 mm or less, 4.75 mm or less, 5.00 mm or less, 6.00 mm or less, 7.00 mm or less, 8.00 mm or less, 9.00 mm or less, 10.00 mm or less, 11.00 mm or less, 12.00 mm or less, 13.00 mm or less, 14.00 mm or less, 15.00 mm or less, 16.00 mm or less, 17.00 mm or less, 18.00 mm or less, 19.00 mm or less, 20.00 mm or less, 25.00 mm or less, 30.00 mm or less, 35.00 mm or less, 40.00 mm or less, 45.00 mm or less, 50.00 mm or less, or 50.00 mm or more;
(lvii) said PPGs comprise particles comprising a swell capacity of 10.0 or less, 10.0 or more, 12.5 or more, 15.0 or more, 17.5 or more, 20.0 or more, 22.5 or more, 25.0 or more, 27.5 or more, 30.0 or more, 32.5 or more, 35.0 or more, 37.5 or more, 40.0 or more, 42.5 or more, 45.0 or more, 47.5 or more, 50.0 or more, 52.5 or more, 55.0 or more, 57.5 or more, 60.0 or more, 62.5 or more, 65.0 or more, 67.5 or more, 70.0 or more, 72.5 or more, 75.0 or more, 77.5 or more, 80.0 or more, 82.5 or more, 85.0 or more, 87.5 or more, 90.0 or more, 92.5 or more, 95.0 or more, 97.5 or more, 100.0 or more, 105.00 or more, 110.00 or more, 115.00 or more, 120.00 or more, 125.00 or more, 130.00 or more, 135.00 or more, 140.00 or more, 145.00 or more, 150.00 or more, 155.00 or more, 160.00 or more, 165.00 or more, 170.00 or more, 175.00 or more, 180.00 or more, 185.00 or more, 190.00 or more, 195.00 or more, or 200.00 or more;
(lviii) said PPGs comprise an elongation value of 2.0 or less, 2.0 or more, 2.5 or more, 3.0 or more, 3.5 or more, 4.0 or more, 4.5 or more, 5.0 or more, 5.5 or more, 6.0 or more, 6.5 or more, 7.0 or more, 7.5 or more, 8.0 or more, 8.5 or more, 9.0 or more, 9.5 or more, or 10.0 or more after re-crosslinking;
(lix) said PPGs comprise acrylamide and/or acrylic acid polymers;
(lx) said PPGs comprise 1% acrylic acid and 99% acrylamide;
(lxi) said PPGs comprises 10% acrylic acid and 90% acrylamide;
(lxii) said PPGs comprise 55% acrylic acid and 45% acrylamide;
(lxiii) said PPGs comprise 70% acrylic acid and 30% acrylamide;
(lxiv) said PPGs comprises acrylamide and/or ATBS polymers;
(lxv) said PPG may be re-crosslinked in the amount of time necessary to achieve a desired result;
(lxvi) said PPG may be re-crosslinked in 1 day or less, 1 day or more, 2 days or more, 3 days or more, 4 days or more, 5 days or more, 6 days or more, 7 days or more, 8 days or more, 9 days or more, or 10 days or more; or
(lxvii) a combination of any two or more of (i)-(lxvi)

3-4. (canceled)

5. The composition of claim 2, embodiment (iii), wherein:
(1) at least one re-crosslinker is added before swelling;
(2) at least one re-crosslinker is added after swelling;
(3) at least one re-crosslinker is added during swelling;
(4) said at least one re-crosslinker is added when the re-crosslinkable PPG is in an unswollen, partially swollen, and/or substantially swollen state; or
(5) a combination of any two or more of (1)-(4).

6-10. (canceled)

11. The composition of claim 2, embodiment (v), wherein said decreased level of crosslinking is obtained by:
(1) the usage of reduced amounts of cross-linker;
(2) the usage of less efficient cross-linkers;
(3) the usage of specific monomers or monomer combinations;
(4) effecting the cross-linking reaction for a shorter duration; or
(5) the addition of one or more polymers comprising soluble linear chains or any combination of the foregoing.

12-13. (canceled)

14. The composition of claim 2 embodiment (vii), wherein:
(1) said re-crosslinkable PPGs comprising 90% acrylamide and 10% acrylic acid and comprise a higher value of swell capacity for crosslinker levels of between 10 ppm to about 45 ppm as compared to re-crosslinkable PPGs comprising acrylamide and acrylic acid where the crosslinker level is about 100 ppm or more;
(2) said re-crosslinkable PPGs comprise 70% acrylamide and 30% acrylic acid and comprise a higher value of swell capacity for crosslinker levels of between 15 ppm to about 35 ppm as compared to re-crosslinkable PPGs comprising acrylamide and acrylic acid where the crosslinker level is about 100 ppm or more; or
(3) a combination of (1) and (2).

15-43. (canceled)

44. A composition suitable for use in conformance control comprising
(i) one or more re-crosslinkable, swellable preformed particle gels (“PPGs”) which are suitable for use as a conformance control agent, wherein said one or more re-crosslinkable PPGs are dispersible in water and comprise soluble linear chains which facilitate re-crosslinking and
(ii) at least one re-crosslinker which is suitable for converting the one or more re-crosslinkable PPGs into a viscoelastic gel.

45-71. (canceled)

71. A system for use in conformance control comprising
(i) the composition comprising one or more re-crosslinked preformed particle gels (“PPGs”) suitable for use as a conformance control agent of claim 1; and
(ii) a subterranean formation having the composition of (i) therein.

72. The system of claim 71 wherein:
(i) said one or more re-crosslinkable PPGs are converted into a gel during use as a conformance control agent;
(ii) the one or more re-crosslinkable PPGs are converted into a gel or re-crosslinked below the surface;
(iii) said system further comprises a fluid conduit disposed in an injection wellbore;
(iv) said system further comprises a pump configured to pump the composition downhole, such as, for example through a fluid conduit;
(v) said system further comprises a pump configured to pump the composition downhole, such as, for example through a fluid conduit;
(vi) said system is suitable for use in enhanced oil recovery;
(vii) said system is suitable for use in chemical flooding, e.g., polymer flooding, alkaline polymer flooding, alkali-polymer-surfactant enhanced oil recovery, micellar polymer flooding, and surfactant polymer flooding;
(viii) said system is suitable for use in one or more of (1) water and gas shutoff, (2) fluid loss control, (3) zone abandonment, (4) water and gas coning, squeeze and recompletion, (5) chemical liner completions and lost circulation during drilling operations and (6) plugging during drilling and drilling completion;
(ix) the use thereof as a conformance control agent provides for enhanced hydrocarbon recovery and/or improved sweep efficiency;
(x) the use thereof as a conformance control agent provides for efficient blockage of high permeability zones; or
(xi) a combination of any two or more of (i)-(x).

73-91. (canceled)

92. A method of enhanced oil recovery, the method comprising:
(i) obtaining or providing one or more compositions of claim 1 and optionally at least one re-crosslinker;
(ii) placing the one or more compositions in a subterranean formation downhole; and
(iii) extracting material comprising petroleum from the subterranean formation downhole via a production wellbore.

93. The method of claim 92, wherein:
(1) re-crosslinking of the one or more re-crosslinkable PPGs occurs in the subterranean formation;
(2) the one or more compositions comprising one or more re-crosslinkable PPGs and at least one re-crosslinker are placed downhole via an injection wellbore;
(3) the extraction is effected using a production wellbore;
(4) the placing of the composition in the subterranean formation downhole comprises placing the one or more compositions in a producing zone downhole, and wherein the extracting of the material comprising petroleum from the subterranean formation downhole comprises extracting of the material from the producing zone;
(5) said method comprises the use of an aqueous liquid comprising at least one of water, brine, produced water, flowback water, brackish water, and sea water;
(6) a re-crosslinking agent comprising one or more polysaccharides is added to said composition; or
(7) a combination of any two or more of (1)-(6).

94-105. (canceled)

106. The composition of claim 2, embodiment (xlvii), wherein:
(1) said conventional crosslinking PPG comprises 5 parts or less, 5 parts or more, 10 parts or more, 15 parts or more, 20 parts or more (of 100 parts) of said blend;
(2) said linear polymer comprises 10 parts or less, 10 parts or more, 15 parts or more, 20 parts or more (of 100 parts) of said blend;
(3) the linear polymer comprises dried polyacrylamide (DPAM); or
(4) a combination of any two or more of (1)-(3).

107-123. (canceled)

124. The composition of claim 2, embodiment (lix), wherein:
(1) the percentage of acrylamide in the polymer comprises 1% or less, 1% or more, 10% or more, 20% or more, 30% or more, 40% or more, 50% or more, 60% or more, 70% or more, 80% or more, 90% or more, or 99% or more;
(2) the percentage of acrylic acid in the polymer comprises 1% or less, 1% or more, 10% or more, 20% or more, 30% or more, 40% or more, 50% or more, 60% or more, 70% or more, 80% or more, 90% or more, or 99% or more;
(3) the percentage of acrylic acid in the polymer comprises 100%; or
(4) a combination of any two or more of (1)-(3).

125-131. (canceled)

132. The composition of claim 2, embodiment (lxiv), wherein:
(1) the percentage of acrylamide in the polymer comprises 1% or less, 1% or more, 10% or more, 20% or more, 30% or more, 40% or more, 50% or more, 60% or more, 70% or more, 80% or more, 90% or more, or 99% or more;
(2) the percentage of ATBS in the polymer comprises 1% or less, 1% or more, 10% or more, 20% or more, 30% or more, 40% or more, 50% or more, 60% or more, 70% or more, 80% or more, 90% or more, or 99% or more
(3) said PPG comprises 10% ATBS and 90% acrylamide; or
(4) a combination of any two or more of (1)-(3).

133-138. (canceled)

139. A method of conformance control, wherein said method comprises adding an amount of one or more re-crosslinkable and swellable preformed particle gels (“PPGs”) according to claim 1 and at least one re-crosslinker that is effective to act as a conformance control agent, wherein said one or more re-crosslinkable PPGs comprise a decreased level of crosslinking resulting in re-crosslinkable PPGs that comprise an amount of linear chains sufficient to facilitate re-crosslinking.

140. The method of claim 139, wherein:
(i) said one or more re-crosslinkable PPGs are re-crosslinkable by the addition of at least one water soluble re-crosslinker, optionally wherein the water soluble re-crosslinker comprises a transitional metal, organic, and/or borate;
(ii) said one or more re-crosslinkable PPGs are re-crosslinkable by the addition of at least one water soluble re-crosslinker, further wherein said water soluble re-crosslinker comprises any transitional multivalent ion;
(iii) said one or more re-crosslinkable PPGs are re-crosslinkable by the addition of at least one water soluble re-crosslinker, further wherein said water soluble re-crosslinker comprises chromium propionate;
(iv) the decreased level of crosslinking in the re-crosslinkable PPG is obtained by blending a conventional crosslinking PPG with a linear polymer, optionally wherein the linear polymer comprises dried polyacrylamide (DPAM);
(v) the decreased level of crosslinking in the re-crosslinkable PPG is obtained by blending a conventional crosslinking PPG with a linear polymer, and further wherein said conventional crosslinking PPG comprises 5 parts or less, 5 parts or more, 10 parts or more, 15 parts or more, 20 parts or more (of 100 parts) of said linear polymer, optionally wherein the linear polymer comprises dried polyacrylamide (DPAM);
(vi) the decreased level of crosslinking in the re-crosslinkable PPG is obtained by blending a conventional crosslinking PPG with a linear polymer, and further wherein said conventional crosslinking PPG comprises 5 parts or less, 5 parts or more, 10 parts or more, 15 parts or more, 20 parts or more (of 100 parts) of said linear polymer, and further wherein said linear polymer comprises 10 parts or less, 10 parts or more, 15 parts or more, 20 parts or more (of 100 parts) of said linear polymer, optionally wherein the linear polymer comprises dried polyacrylamide (DPAM);
(vii) said re-crosslinkable PPGs having decreased level of crosslinking are obtained by dissolving DPAM in a conventional crosslinking level PPG monomer solution and incubating these constituents under reaction conditions effective to form a double polymer network;
(viii) a re-crosslinking agent is added to said re-crosslinkable PPG comprising linear chains;
(ix) a re-crosslinking agent comprising polysaccharides is added to said re-crosslinkable PPG;
(x) said re-crosslinkable PPGs comprise 0 ppm on monomer of a crosslinker in the polymer;
(xi) the monomer composition used to produce said re-crosslinkable PPGs comprises a crosslinker, e.g., a stable or covalent crosslinker, optionally wherein said crosslinker comprises methylene bisacrylamide (“MBA”);
(xii) the monomer composition used to produce said re-crosslinkable PPGs comprises a crosslinker, e.g., a stable or covalent crosslinker, wherein said crosslinker comprises methylene bisacrylamide (“MBA”), and further wherein said MBA comprises 0.1 ppm or less, 0.5 ppm or less, 1.0 ppm or less, 2.0 ppm or less, 3.0 ppm or less, 4.0 ppm or less, 5.0 ppm or less, 6.0 ppm or less, 7.0 ppm or less, 8.0 ppm or less, 9.0 ppm or less, 10.0 ppm or less, 12.5 ppm or less, 15.0 ppm or less, 17.5 ppm or less, 20.0 ppm or less, 22.5 ppm or less, 25.0 ppm or less, 27.5 ppm or less, 30.0 ppm or less, 32.5 ppm or less, 35.0 ppm or less, 37.5 ppm or less, 40.0 ppm or less, 42.5 ppm or less, 45.0 ppm or less, 47.5 ppm or less, 50.0 ppm or less, 52.5 ppm or less, 55.0 ppm or less, 57.5 ppm or less, 60.0 ppm or less, 62.5 ppm or less, 65.0 ppm or less, 67.5 ppm or less, 70.0 ppm or less, 72.5 ppm or less, 75.0 ppm or less, 77.5 ppm or less, 80.0 ppm or less, 82.5 ppm or less, 85.0 ppm or less, 87.5 ppm or less, 90.0 ppm or less, 92.5 ppm or less, 95.0 ppm or less, 97.5 ppm or less, or 100.0 ppm or less in the polymer;
(xiii) said re-crosslinkable PPGs comprise any diameter that is suitable to obtain a desired result, e.g., use as a conformance control agent;
(xiv) said re-crosslinkable PPGs comprise a diameter of 0.10 μm or less, 0.5 μm or less, 1.0 μm or less, 10.0 μm or less, 50.0 μm or less, 0.1 mm or less, 0.15 mm or less, 0.20 mm or less, 0.25 mm or less, 0.30 mm or less, 0.35 mm or less, 0.40 mm or less, 0.45 mm or less, 0.50 mm or less, 0.55 mm or less, 0.60 mm or less, 0.65 mm or less, 0.70 mm or less, 0.75 mm or less, 0.80 mm or less, 0.90 mm or less, 0.95 mm or less, 1.00 mm or less, 1.10 mm or less, 1.20 mm or less, 1.30 mm or less, 1.40 mm or less, 1.50 mm or less, 1.60 mm or less, 1.70 mm or less, 1.80 mm or less, 1.90 mm or less, 2.00 mm or less, 2.25 mm or less, 2.50 mm or less, 2.75 mm or less, 3.00 mm or less, 3.25 mm or less, 3.50 mm or less, 3.75 mm or less, 4.00 mm or less, 4.25 mm or less, 4.50 mm or less, 4.75 mm or less, 5.00 mm or less, 6.00 mm or less, 7.00 mm or less, 8.00 mm or less, 9.00 mm or less, 10.00 mm or less, 11.00 mm or less, 12.00 mm or less, 13.00 mm or less, 14.00 mm or less, 15.00 mm or less, 16.00 mm or less, 17.00 mm or less, 18.00 mm or less, 19.00 mm or less, 20.00 mm or less, 25.00 mm or less, 30.00 mm or less, 35.00 mm or less, 40.00 mm or less, 45.00 mm or less, 50.00 mm or less, or 50.00 mm or more;
(xv) said re-crosslinkable PPG comprises a swell capacity of 10.0 or less, 10.0 or more, 12.5 or more, 15.0 or more, 17.5 or more, 20.0 or more, 22.5 or more, 25.0 or more, 27.5 or more, 30.0 or more, 32.5 or more, 35.0 or more, 37.5 or more, 40.0 or more, 42.5 or more, 45.0 or more, 47.5 or more, 50.0 or more, 52.5 or more, 55.0 or more, 57.5 or more, 60.0 or more, 62.5 or more, 65.0 or more, 67.5 or more, 70.0 or more, 72.5 or more, 75.0 or more, 77.5 or more, 80.0 or more, 82.5 or more, 85.0 or more, 87.5 or more, 90.0 or more, 92.5 or more, 95.0 or more, 97.5 or more, 100.0 or more, 105.00 or more, 110.00 or more, 115.00 or more, 120.00 or more, 125.00 or more, 130.00 or more, 135.00 or more, 140.00 or more, 145.00 or more, 150.00 or more, 155.00 or more, 160.00 or more, 165.00 or more, 170.00 or more, 175.00 or more, 180.00 or more, 185.00 or more, 190.00 or more, 195.00 or more, or 200.00 or more;
(xvi) said re-crosslinkable PPGs when re-crosslinked comprise an elongation value of 2.0 or less, 2.0 or more, 2.5 or more, 3.0 or more, 3.5 or more, 4.0 or more, 4.5 or more, 5.0 or more, 5.5 or more, 6.0 or more, 6.5 or more, 7.0 or more, 7.5 or more, 8.0 or more, 8.5 or more, 9.0 or more, 9.5 or more, or 10.0 or more when re-crosslinked;
(xvii) said PPGs comprise acrylamide and/or acrylic acid polymers;
(xviii) said PPGs comprise acrylamide and/or acrylic acid polymers and the percentage of acrylamide in the polymer comprises 1% or less, 1% or more, 10% or more, 20% or more, 30% or more, 40% or more, 50% or more, 60% or more, 70% or more, 80% or more, 90% or more, or 99% or more;
(xix) said PPGs comprise acrylamide and/or acrylic acid polymers and the percentage of acrylamide in the polymer comprises 1% or less, 1% or more, 10% or more, 20% or more, 30% or more, 40% or more, 50% or more, 60% or more, 70% or more, 80% or more, 90% or more, or 99% or more and wherein the percentage of acrylic acid in the polymer comprises 1% or less, 1% or more, 10% or more, 20% or more, 30% or more, 40% or more, 50% or more, 60% or more, 70% or more, 80% or more, 90% or more, or 99% or more;
(xx) said PPGs comprise acrylamide and/or acrylic acid polymers and the percentage of acrylic acid in the polymer comprises 1% or less, 1% or more, 10% or more, 20% or more, 30% or more, 40% or more, 50% or more, 60% or more, 70% or more, 80% or more, 90% or more, or 99% or more;
(xxi) said PPGs comprise acrylamide and acrylic acid and the percentage of acrylamide in the polymer is 99% and the percentage of acrylic acid is 1%;
(xxii) said PPGs comprise acrylamide and acrylic acid and the percentage of acrylamide in the polymer is 90% and the percentage of acrylic acid is 10%;
(xxiii) said PPGs comprise acrylamide and acrylic acid and the percentage of acrylamide in the polymer is 90% and the percentage of acrylic acid is 10%;
(xxiv) said PPGs comprise acrylamide and acrylic acid and the percentage of acrylamide in the polymer is 45% and the percentage of acrylic acid is 55%;
(xxv) said PPGs comprise acrylamide and acrylic acid and the percentage of acrylamide in the polymer is 30% and the percentage of acrylic acid is 70%;
(xxvi) said PPGs comprise acrylic acid and the percentage of acrylic acid polymer is 100%;
(xxvii) said re-crosslinkable PPGs may be re-crosslinked in the amount of time necessary to achieve a desired result;
(xxviii) said re-crosslinkable PPGs may be re-crosslinked in 1 day or less, 1 day or more, 2 days or more, 3 days or more, 4 days or more, 5 days or more, 6 days or more, 7 days or more, 8 days or more, 9 days or more, or 10 days or more;
(xxix) said re-crosslinkable PPGs are used in any method where conventional PPGs may be used;
(xxx) re-crosslinking of the one or more re-crosslinkable PPGs occurs in a subterranean formation;
(xxxi) the one or more re-crosslinkable PPGs and at least one re-crosslinker are placed downhole via an injection wellbore;
(xxxii) the one or more re-crosslinkable PPGs are placed in a subterranean formation downhole, which placing comprises placing the one or more re-crosslinkable PPGs in a producing zone downhole;
(xxxiii) said method comprises the use of an aqueous liquid comprising at least one of water, brine, produced water, flowback water, brackish water, and sea water; or
(xxxiv) a combination of any two or more of (i)-(xxxiii).

141-174. (canceled)

175. A method for remediation of a zone within a subterranean formation bearing heavy/viscous oil to inhibit breakthrough of water from a water injection well via the zone into a production well, the zone comprised of a void space, a halo region, or both, within the zone due to production of the heavy/viscous oil through the production well, the zone thereby allowing for pressure communication between the injection well and the production well, which method comprises:
(i) injecting a composition into the zone via the injection well, the composition comprising re-crosslinkable PPGs comprising soluble linear chains and at least one re-crosslinker or a composition containing according to claim 1;
(ii) allowing the PPGs to set for a time sufficient to thereby form a plug which reduces flow communication of water between the injection well and the production well.

176. The method of claim 175 wherein the displacement fluid is selected from water, alcohols, fuel oil or crude oil, optionally wherein the displacement fluid is water.

177-182. (canceled)
